(19) United States
(12) Patent Application Publication
(10) Pub. No.: US 2026/0226374 A1
(43) Pub. Date: Aug. 6, 2026

(54) AUTOMATIC DISHWASHING COMPOSITION COMPRISING A STRUCTURAL POLYPEPTIDE

(71) Applicant: AMSILK GMBH, Neuried (DE)

(72) Inventors: Andreas SCHMIDEDER, Velden (DE); Mauro DAVANZO, Ludwigshafen am Rhein (DE)

(21) Appl. No.: 19/152,722

(22) PCT Filed: Feb. 1, 2024
(86) PCT No.: PCT/EP2024/052457

§ 371 Date: Jul. 31, 2025

(30) Foreign Application Priority Data
Feb. 2, 2023 (EP) 23154764.7

(51) Int. Cl. C11D 3/384; C11D 7/46

(52) U.S. Cl. CPC C11D 3/384; C11D 7/46; C11D 2111/14

(57) ABSTRACT

The present invention relates to an automatic dishwashing composition comprising a structural polypeptide, a method for machine cleaning of dishware, the use of a structural polypeptide in an automatic dishwashing composition and the use of the automatic dishwashing composition for the treatment of soiled dishware.

### CROSS REFERENCE TO RELATED APPLICATIONS

This application is a U.S. National Stage of PCT/EP2024/052457, international filing date Feb. 1, 2024, which claims priority to European Application No. 23154764.7, filing date Feb. 2, 2023.

### REFERENCE TO SEQUENCE LISTING IN ELECTRONIC FORMAT

The contents of the electronic sequence listing (558-120-pct-sequence-listing.xml; Size: 14,404 bytes; and Date of Creation: Jan. 29, 2024) is herein incorporated by reference in its entirety.

The present invention relates to an automatic dishwashing composition comprising a structural polypeptide, a method for machine cleaning of dishware, the use of a structural polypeptide in an automatic dishwashing composition and the use of the automatic dishwashing composition for the treatment of soiled dishware.

### BACKGROUND OF THE INVENTION

In typical machine dishwashing processes (also denoted as automatic dishwashing, short ADW) in the domestic and the commercial sector, including I&I (industrial and institutional) applications, the objects to be washed, such as tableware or cookware, soiled with food or other matter, are subjected to a number of treatments in a sequence of zones and/or cycles. The cleaning process generally consists of a plurality of successive steps, comprising the actual cleaning operation, where in a wash zone the soiled dishware is usually sprayed with a liquid cleaning medium at a pressure sufficient to detach the soil present on the objects to be washed. The wash zone may be preceded by at least one pre-treatment zone, e.g. for the mechanical removal of loosely adhering food residues, in which the dishware is also contacted with water or another liquid cleaning medium. The actual cleaning process is usually followed by at least one rinsing step and the drying of the cleaned dishware. These operations are conducted in more or less automated form, the central unit used being a machine dishwasher in which at least the cleaning step and generally also the subsequent rinsing step and/or the drying step are conducted.

In machine dishwashers for the domestic sector, the soiled dishware is generally cleaned in a single chamber, and the aforementioned treatment steps proceed successively in a controlled program. Fresh water passes through the softening unit to the pump well and is sprayed by means of moving spray arms over the ware to be cleaned. Water-insoluble substances rinsed off are filtered out in the pump well. In the first cleaning cycle(s), a generally alkaline cleaning composition is added to the liquid cleaning medium, heated to the set temperature and distributed over the ware to be cleaned. In the following rinse cycle(s), a rinse aid is added to the treatment liquid, which reduces the surface tension, as a result of which the treatment liquid runs more easily off the ware. After the last rinse cycle, the contents are dried. The components used in the ADW process, such as water treatment agents, cleaning-active components, rinse aids, etc., can be used either in the form of individual components or in multicomponent formulations.

Commercial machine dishwashers consist basically of stationary bath tanks from which an essentially aqueous cleaning solution is jetted or sprayed onto the dishware, which e.g. moves past these baths on a conveyor belt, such that the used solution flows back into the bath tanks again. Water enters the last bath tank, flows via overflows in the manner of a cascade through all the other tanks and leaves the machine via the overflow of the first tank. The application of a generally highly alkaline cleaning solution takes place e.g. with the aid of nozzles provided therefor or a specific spraying system normally arranged in the middle region of the machine.

Today's automatic dishwashing compositions are complex formulations comprising a number of different ingredients, like sequestering/dispersing agents, nonionic surfactants, enzymes, bleaches, corrosion inhibitors, thickeners, etc. These can be fed to the dishwasher individually or in the form of mixtures of two or more components. A multitude of different forms of ADW detergent compositions is known in the art. Possible forms include powders, granules, gels, pastes, liquids, tablets (tabs), capsules (caps), water soluble pouches (liquid tabs), water soluble containers, etc. Water-soluble film-forming polymers, in particular with special release characteristics, can be used as a sheath or as a coating for the complete dishwashing compositions or at least one of the components thereof. Capsules or containers may have a single compartment or may be multi-compartment system. Thus, it is possible to use components with stability problems, e.g. because they are hygroscopic or incompatible with other ingredients, even in complex dishwashing compositions. Accordingly, the ADW compositions may also comprise a mixture of two or more forms, e.g. a gel component and a powder component.

In the domestic sector so called “monodose” products are popular that contain the correct amount of a dishwashing composition sufficient for a single dishwashing operation. Very attractive for consumers are also gel formulations because they are easier to dispense than low-viscosity products and are aesthetically pleasing, especially in form of transparent or translucent gels.

ADW compositions have to fulfil a complex profile of demands. It encompasses good cleaning of the soiled dishware, to leave it shiny without streaks and deposits, not to damage the dishware even with a large number of cleaning applications, in particular to protect the surface, to be universal for different types of surfaces and various types of dirt and allow good drying of the cleaned items. Spotting and filming of dishes and in particular glassware and cutlery is an essential criteria by which the performance of a dishwashing formulation is judged. Spotting refers to discrete residues on glassware which are formed when water droplets evaporate and leave behind dissolved solids. Filming refers to a uniform deposition over a large, continuous portion of a glass surface. ADW formulations should have inhibiting action with respect to both inorganic and organic film deposits. Inorganic film deposits primarily result from calcium and magnesium salts present in the water and the builders used in standard dishwashing compositions. Organic film deposits are especially soil constituents from the rinse liquor, for example protein, starch and fat deposits. There is also an increasing awareness to use environmentally friendly and/or bio-based ingredients in ADW compositions.

There is a continuing need for automatic dishwashing compositions that have at least one, preferably several, of the following properties: a good surface protection, improved spotting and filming performance even when water of high hardness is employed and good drying properties. The further application properties of the ADW composition, in particular the cleaning effect, should not be negatively affected. The components contained in the ADW compositions should be non-toxic, not environmentally harmful and safe for humans and animals. It should be possible to provide a product in form of a gel.

It has now been found that, surprisingly, structural polypeptides, such as silk polypeptides, are suitable for the formulation of ADW compositions with improved application properties. Silk polypeptides are polymers that exhibit exceptional application properties and can impart ADW formulations with a variety of benefits, including a good surface protection, improved spotting and filming performance and good drying properties. Structural polypeptides, such as silk polypeptides, are biocompatible, non-toxic and environmental friendly and suitable for the formulation of any form of machine dishwashing compositions, such as gels and further forms.

### SUMMARY OF THE INVENTION

Described herein is a dishwashing composition. This diswashing composition comprises:
a) a structural polypeptide, especially a silk polypeptide and
b) at least one builder.
   Said diswashing composition is particularly a hand dishwashing composition or an automatic dishwashing composition.
   Thus, a first object of the invention is an automatic dishwashing composition, comprising:
a) a structural polypeptide, especially a silk polypeptide and
b) at least one builder.
   A preferred embodiment is an automatic dishwashing composition, comprising:
a) at least one structural polypeptide,
b) at least one builder (also referred to as sequestrant, builder material, complexing agent, chelator, chelating agent, softener or crystal growth inhibitor),
c) optionally at least one enzyme,
d) optionally at least one bleach component,
e) optionally at least one rheology modifier (also referred to as thickener),
f) optionally at least one further additive different from components a) to e), preferably selected from surfactants, bases, corrosion inhibitors, defoamers, dyes, fragrances, fillers, tableting aids, disintegrants, solubilizers, organic solvents, electrolytes, optical brighteners, hydrotropes, antiredeposition agents, antimicrobial ingredients, antioxidants and mixtures thereof, and
g) optionally water.

Described herein is a method for cleaning of dishware in which the dishware to be cleaned is contacted with a dishwashing composition as defined above and in the following.

Said method is particularly a method for cleaning of dishware by hand or a method for machine cleaning of dishware.
Thus, a further object of the invention is a method for machine cleaning of dishware, in which the dishware to be cleaned is contacted with an automatic dishwashing composition as defined above and in the following.

Described herein is the use of a structural polypeptide, especially a silk polypeptide, in a dishwashing composition. Said dishwashing composition is particularly a hand dishwashing composition or an automatic dishwashing composition. Thus, a further object of the invention is the use of a structural polypeptide, especially a silk polypeptide, in an automatic dishwashing composition.

Described herein is the use of a dishwashing composition, as defined above and in the following, in the treatment of soiled dishware for reducing spotting and filming of the dishware, in particular of glassware and cutlery,
imparting the dishware with a good shine,
improving the soil removability of the dishware,
preventing resoiling of the dishware,
imparting the dishware with a surface protection, in particular preventing corrosive changes of the surfaces of glassware, reducing the surface tension of the dishware,
reducing or eliminating the need for a separate rinse aid product,
improving the drying of the dishware.
   Particularly, the dishwashing composition is a hand dishwashing composition or an automatic dishwashing composition. Thus, a further object of the invention is the use of an automatic dishwashing composition, as defined above and in the following, in the treatment of soiled dishware in an automatic dishwasher for reducing spotting and filming of the dishware, in particular of glassware and cutlery,
imparting the dishware with a good shine, improving the soil removability of the dishware,
preventing resoiling of the dishware,
imparting the dishware with a surface protection, in particular preventing corrosive changes of the surfaces of glassware,
reducing the surface tension of the dishware,
reducing or eliminating the need for a separate rinse aid product,
improving the drying of the dishware.

This summary of the invention does not necessarily describe all features of the present invention. Other embodiments will become apparent from a review of the ensuing detailed description.

### DETAILED DESCRIPTION OF THE INVENTION

Before the present invention is described in detail below, it is to be understood that this invention is not limited to the particular methodology, protocols and reagents described herein as these may vary. It is also to be understood that the terminology used herein is for the purpose of describing particular embodiments only, and is not intended to limit the scope of the present invention which will be limited only by the appended claims. Unless defined otherwise, all technical and scientific terms used herein have the same meanings as commonly understood by one of ordinary skill in the art.

Preferably, the terms used herein are defined as described in “A multilingual glossary of biotechnological terms: (IUPAC Recommendations)”, Leuenberger, H. G. W, Nagel, B. and Kölbl, H. eds. (1995), Helvetica Chimica Acta, CH-4010 Basel, Switzerland).

Several documents are cited throughout the text of this specification. Each of the documents cited herein (including all patents, patent applications, scientific publications, manufacturer's specifications, instructions, GenBank Accession Number sequence submissions etc.), whether supra or infra, is hereby incorporated by reference in its entirety. Nothing herein is to be construed as an admission that the invention is not entitled to antedate such disclosure by virtue of prior invention.

In the following, the elements of the present invention will be described. These elements are listed with specific embodiments. However, it should be understood that they may be combined in any manner and in any number to create additional embodiments. The variously described examples and preferred embodiments should not be construed to limit the present invention to only the explicitly described embodiments. This description should be understood to support and encompass embodiments which combine the explicitly described embodiments with any number of the disclosed and/or preferred elements. Furthermore, any permutations and combinations of all described elements in this application should be considered disclosed by the description of the present application unless the context indicates otherwise.

The term “dishwashing composition”, as used herein, refers to a composition designed for washing dishes in water. The term “dishwashing composition” encompasses a hand dishwashing composition or an automatic dishwashing composition.

Structural polypeptides, such as silk polypeptides, are particularly advantageous for use in automatic dishwashing compositions which must meet a complex property profile. The automatic dishwashing composition of the invention has at least one, preferably two, three or more of the following advantages:
Structural polypeptides, in particular silk polypeptides, are polymers that exhibit exceptional application properties and can impart ADW formulations with a variety of benefits.
The composition of the invention leads to an efficient reduction of spotting and filming. After the cleaning process the dishware and in particular glassware and cutlery has a good shine and shows remarkably less water-marks, smears and/or spots in comparison to conventional products from the prior art.
The composition shows good cleaning of the dishware even with hard water and heavy soiling. It is suitable for improving the soil removability and/or preventing resoiling of the dishware.
The composition of the invention is suitable to impart the dishware with a surface protection. In particular, it does not corrosively change the surfaces of glassware, even upon repeated use, in particular does not cause clouding, smearing or scratches, nor iridescence of glass surfaces.
The composition of the invention is suitable to impart the dishware with a reduced surface tension. The contact angle of deionized water on dishware, in particular glasses, washed in a dishwasher with the automatic dishwashing composition of the invention is remarkably reduced in comparison to conventional products from the prior art. Dishware treated with the composition of the invention shows improved drying properties.
The composition shows effective action even with very low application quantities.
The structural proteins, in particular the silk proteins, contained in the ADW compositions according to the invention are biocompatble, non-toxic, not environmentally harmful and safe for humans and animals. Especially the silk proteins are made exclusively from renewable sources, are 100% biodegradable and free of microplastic. In regulatory and environmental issues this can be advantageous over compositions based on conventional ingredients.
The structural proteins, in particular the silk proteins, are suitable for the use in phosphate free formulation.
The structural proteins, in particular the silk proteins, are suitable for the use in a great variety of different forms, e.g. gels, aqueous solutions and solutions in organic solvents. The composition is particularly suitable for monodose products.

Without wishing to be bound by any theory, it is believed that the employed structural polypeptides, in particular silk polypeptides, are suitable for a surface modification of the dishware that imparts the dishware with improved properties. The structural polypeptide adheres to the surfaces and thus allows efficient cleaning and drainage of the wash liquor and/or rinsing water. This helps prevent the generation of aqueous droplets which, upon drying, can result in deposition of residues on the dishware surface and formation of visible spots or streaks. Surprisingly, this surface-modification can be affected by delivering the structural polypeptide into the main wash solution, together with the rest of the cleaning composition, and remains on the surface of the dishware during the rinse cycles and even afterwards. Thus, the use of the structural polypeptide in the ADW composition enables good water drainage during the rinsing phase and leaves a protection against surface damage and resoiling. This reduces or eliminates the need for a separate rinse aid product.

In the sense of the present application, the term dishware encompasses all kinds of soiled objects that can be subjected to an automated cleaning process in a dishwasher. Thus, the term dishware encompasses dinnerware (tableware), cookware, cutlery, kitchen utensils, and other items for practical and decorative purposes.

The automatic dishwashing composition of the invention may be in any form, such as powders, granules, gels, pastes, liquids, tablets (tabs), capsules (caps), water soluble pouches (liquid tabs), water soluble containers, etc. Water-soluble film-forming polymers, in particular with special release characteristics, can be used as a sheath or as a coating for the complete dishwashing compositions or at least one of the components thereof. Capsules or containers may have a single compartment or may be a multicompartment system.

In a preferred embodiment, the automatic dishwashing composition is in the form of a gel. Especially, the automatic dishwashing composition is in gel form or the automatic dishwashing composition is a multicompartment formulation containing the structural polypeptide in gel form or as a solution. Preferred solvents are water, at least partly water-miscible organic solvents and mixtures thereof. In a special embodiment, the automatic dishwashing composition is a multicompartment formulation containing the structural polypeptide in form of a hydrogel.

In a preferred embodiment, the automatic dishwashing composition is in the form of a monodose products (i.e. that contains the correct amount of a dishwashing composition sufficient for a single dishwashing operation).

In a further preferred embodiment, the automatic dishwashing composition is in the form of a unit dose form. Products in unit dose form include tablets, capsules, sachets, pouches, containers, etc. The automatic dishwashing composition of the invention is preferably in the form of a multicompartment formulation. Multicompartment formulations (also multi-chamber or multifunctional formulations/systems) are water-soluble multicompartment packs, produced with water soluble polymers, e.g. in the form of films or shaped bodies, having 1, 2, 3, 4, 5, 6 or more than 6 individual sections. Preferred for use herein are tablets, compositions coated with or wrapped in a water-soluble polymer film (including tablets, capsules, sachets, pouches) and containers prepared from water-soluble polymers. Each compartment (section) of a multicompartment formulation may be independently filled with powders, granules, gels, pastes, liquids, or a combination thereof.

In a possible embodiment, the structural polypeptide a) can be dispensed in a separate compartment of a multicompartment formulation.

The automatic dishwashing composition of the invention is preferably phosphate-free. By “phosphate-free” it is herein understood that the composition comprises less than 1% by weight, preferably less than 0.1%, in particular less than 0.05% by weight, based on the total weight of the composition of phosphate. “Phosphate-free” means that the automatic dishwashing composition is free of alkali metal orthophosphates and polyphosphates, in particular pentasodium triphosphate (sodium tripolyphosphate, STPP).

### Component a) (Structural Polypeptide)

In the context of the present invention, the terms “polypeptide” and “protein” are used interchangeably. They refer to a long chain of amino acids with peptide linkage, e.g. one that is at least 30 amino acids long.

The term “structural polypeptide”, as used herein, refers to any polypeptide which comprises repeat units (repeating building blocks) made of amino acids. The structural polypeptide preferably has the ability to perform polypeptide assembly. In particular, the structural polypeptide is capable of forming protein complexes (aggregates) in formulations, e.g. hydrogels in aqueous formulations. The structural polypeptide may be selected from the group consisting of silk polypeptide (including fibroin), keratin, collagen, and elastin or variants or combinations thereof. The structural polypeptide is particularly a recombinant or synthetic structural polypeptide. The structural polypeptide is preferably a (recombinant or synthetic) silk polypeptide, such as a (recombinant or synthetic) spider silk polypeptide. An exemplarily process for producing a silk polypeptide is described in WO 2006/008163 and in WO 2011/120690.

The term “silk polypeptide”, as used herein, refers to a polypeptide which shows, in comparison to other polypeptides, a quite aberrant amino acid composition. In particular, a silk polypeptide possesses large quantities of hydrophobic amino acids such as glycine or alanine. In addition, a silk polypeptide contains highly repetitive amino acid sequences or repetitive units (repeat units, modules), especially in their large core domain. Based on DNA analysis, it was shown that all silk polypeptide are chains of repetitive units which further comprise a limited set of distinct shorter peptide motifs. The expressions “peptide motif” and “consensus sequence” can be used interchangeably herein. Generally, the silk consensus sequences can be grouped into four major categories: GPGXX, GGX, Ax or (GA)n and spacers. These categories of peptide motifs in silk polypeptides have been assigned structural roles. For example, it has been suggested that the GPGXX motif is involved in a β-turn spiral, probably providing elasticity. The GGX motif is known to be responsible for a glycine-rich 31-helix. Both GPGXX and GGX motifs are thought to be involved in the formation of an amorphous matrix that connects crystalline regions, thereby providing elasticity of the fiber. Alanine-rich motifs typically contain 6-9 residues and have been found to form crystalline β-sheets. The spacers typically contain charged groups and separate the iterated peptide motifs into clusters. The silk polypeptide can perform polypeptide assembly.

Fibroin is a structural polypeptide and a silk polypeptide in the sense of the invention.

The silk polypeptide is particularly a recombinant or synthetic silk polypeptide.

Preferably, the (recombinant or synthetic) silk polypeptide is a (recombinant or synthetic) spider silk polypeptide.

The term “polypeptide-assembly”, as used herein, refers to a process in which a disordered system of pre-existing polypeptides forms an organized structure or pattern as a consequence of specific, local interactions (e.g. van der Waals forces, hydrophobic interactions, hydrogen bonds, and/or salt-bridges, etc.) among the polypeptides themselves, without external direction or trigger although external factors might influence speed and nature of polypeptide-assembly. This particularly means that when two or more disordered and/or unfolded polypeptides are brought into contact, they interact with each other and consequently form a three-dimensional structure. The change from a disordered system to an organized structure or pattern during self-polypeptide assembly is characterized by a transition from a fluid state to a gel-like and/or solid state and a corresponding increase in viscosity. The transition from a fluid state to a gel-like state can be monitored, for example, by optical measurement or rheology measurement. These techniques are known to the skilled person. The transition from a fluid state to a solid state can be monitored, for example, using optical methods.

Preferably, the structural polypeptide conducting polypeptide assembly is a (recombinant or synthetic) silk polypeptide, such as a (recombinant or/synthetic) spider silk polypeptide.

The term “polypeptide aggregates” (or polypeptide complexes), as used herein, refers to polypeptide structures which are formed as a result of polypeptide self-assembly. In the process of polypeptide self-assembly, multiple copies/units of polypeptides self-aggregate into a body or mass without external direction or trigger although external factors might influence speed and nature of self-polypeptide assembly. In the polypeptide aggregates, the different polypeptides are connected with or attached to each other via covalent (e.g. disulfide bridges) and/or non-covalent interactions (e.g. van der Waals forces, hydrophobic interactions, hydrogen bonds, and/or salt-bridges). It should be clear that a polypeptide aggregate encompasses at least two polypeptides. In the context of the present invention, the self-assembly of (recombinant or/synthetic) silk polypeptides is described. During the process of silk polypeptide self-assembly, silk polypeptide aggregates (silk polypeptide complexes) are formed.

The term “hydrogel”, as used herein, refers to a structure that is formed if the concentration of structural polypeptides is high enough to build a continuous network by which the liquid component is immobilized. Said network is preferably formed by polypeptide assembly of the structural polypeptides providing the basis of the hydrogel. In particular, the hydrogel is a hydrophilic polymeric network of structural polypeptides. Said network is stabilized by chemical and/or physical interactions between the structural polypeptides. The network is dispersed throughout an immobilized aqueous phase. The hydrophilicity and stability of the hydrogel permits the penetration and absorption of water (swelling) without dissolving, thus, maintaining its three-dimensional (3D) structure and function.

A preferred embodiment of a hydrogel is a flowable hydrogel. The term “flowable hydrogel”, as used herein, refers to a hydrogel that is capable of flowing, in particular when it is exposed to the force of gravity. A flowable hydrogel is in a liquid state (in the sense that it is not yet self-supporting, meaning that it retain a shape imparted to it without shape-stabilizing encasement). The followability of a hydrogel can easily be determined by the skilled person, e.g. by rheology or viscosity measurements. The followability measurements are preferably preformed under standard conditions (20° C.). Methods for determining the viscosity of gels are described in detail in the following.

Alternatively, the hydrogel is a non-flowable hydrogel. This hydrogel can be converted to a flowable hydrogel by shear-thinning. The same holds for structural polypeptides in the sense of the invention that are in a solid form.

Preferably, the structural polypeptide employed according to the invention is in the form of a hydrogel. More preferably, the structural polypeptide in the form of a hydrogel is a silk polypeptide. In particular, the structural polypeptide in the form of a hydrogel is a recombinant or synthetic silk polypeptide.

Preferably, the structural polypeptide employed according to the invention is in the form of a flowable hydrogel. More preferably, the structural polypeptide in the form of a flowable hydrogel is a silk polypeptide. In particular, the structural polypeptide in the form of a flowable hydrogel is a recombinant or synthetic silk polypeptide.

The hydrogel hereinafter is also referred to as silk protein gel or silkgel. The manufacture of hydrogel is described for example in WO2020035361, WO2022258500 or WO2022258499.

In a preferred embodiment, the automatic dishwashing composition according to the invention comprises a structural polypeptide which can form polypeptide aggregates. In particular, said polypeptide has the potential to assemble into fibrillary structures (i.e. fibrillary aggregates (complexes) of structural polypeptides).

It is preferred that the structural polypeptide is selected from silk polypeptides, keratin, collagen, elastin and combinations thereof. In one embodiment, the silk polypeptide is fibroin. In particular, the structural polypeptide is a recombinant polypeptide, e.g. a recombinant silk polypeptide, keratin, collagen or elastin.

It is more preferred that the structural polypeptide is a silk polypeptide, in particular a recombinant silk polypeptide.

In a preferred embodiment, the (recombinant) silk polypeptide is a spider silk polypeptide. A suitable spider silk polypeptide is a major ampullate silk polypeptide, such as a dragline silk polypeptide, a minor ampullate silk polypeptide, or a flagelliform silk polypeptide of an orb-web spider. Particularly, the silk polypeptide is a spider silk polypeptide, more particularly a recombinant spider silk polypeptide.

In a preferred embodiment, the silk polypeptide comprises or consists of 25 to 4000 amino acids. It is even more preferred that the silk polypeptide comprises or consists of 30 to 1500 amino acids, in particular 35 to 1200 amino acids. in a special embodiment, the silk polypeptide comprises or consists of 60 to 600 amino acids.

In one preferred embodiment, the silk polypeptide consists of a single unit of amino acids. This embodiment is defined in that the protein chain does not have units of several (at least two) of the same or similar sequence motifs. In this embodiment, the silk polypeptide preferably consists of 25 to 250 amino acids, in particular 30 to 150 amino acids.

In an alternative preferred embodiment, the silk polypeptide is a polypeptide with an amino acid sequence which comprises or consists of at least 50% multiple copies of repetitive units. The amino acid sequence may consist of up to 100% multiple copies of repetitive units. More preferably, the silk polypeptide is a polypeptide with an amino acid sequence which comprises or consists of at least 50%, particularly at least 60%, particularly at least 65%, particularly at least 70%, particularly at least 75%, particularly particularly at least 80%, particularly at least 85%, particularly at least 90%, particularly at least 95%, or especially at least 99% multiple copies of repetitive units or of even 100% multiple copies of repetitive units. Said repetitive units may be identical or different.

If the amino acid sequence of the silk polypeptide is a polypeptide that comprises or consists of multiple copies of repetitive units, each repetitive unit preferably comprises or consists of 25 to 250 amino acids, in particular 30 to 150 amino acids.

If the amino acid sequence of the silk polypeptide is a polypeptide that comprises or consists of multiple copies of repetitive units, the total number of amino acids in all repetitive units is preferably in a range of 25 to 3000 amino acids, more preferably 30 to 1500 amino acids, in particular 35 to 1200 amino acids, especially 60 to 600 amino acids.

In a preferred embodiment, the silk polypeptide comprises or consists of at least two identical repetitive units. For example, the silk polypeptide comprises or consists of from 2 to 96 repetitive units, e.g. 2, 3, 4, 5, 6, 7, 8, 9, 10, 11, 12, 13, 14, 15, 16, 17, 18, 19, 20, 21, 22, 23, 24, 25, 26, 27, 28, 29, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, or 96 repetitive units.

In particular, the repetitive units are independently selected from the group consisting of
module C having an amino acid sequence according to SEQ ID NO: 1 (GSSAAAAAAAASGPGGYGPENQGPSGPGGYGPGGP) or variants thereof,
module C^{Cys} having an amino acid sequence according to SEQ ID NO: 2 (GSSAAAAAAAASGPGGYGPENQGPCGPGGYGPGGP) or variants thereof,
module C^{Lys} having an amino acid sequence according to SEQ ID NO: 3 (GSSAAAAAAAASGPGGYGPKNQGPSGPGGYGPGGP) or variants thereof.

Module C^{Cys} (SEQ ID NO: 2) is a variant of module C (SEQ ID NO: 1). In this module, the amino acid Ser at position 25 has been replaced by the amino acid Cys. Module C^{Lys} (SEQ ID NO: 3) is also a variant of module C (SEQ ID NO: 1). In this module, the amino acid Glu at position 20 has been replaced by the amino acid Lys.

The module C variant differs from the reference module C from which it is derived by up to 1, 2, 3, 4, 5, 6, 7, 8, 9, 10, 11, 12, 13, 14 or 15 amino acid changes in the amino acid sequence (i.e. substitutions, additions, insertions, deletions, N-terminal truncations and/or C-terminal truncations). Such a module variant can alternatively or additionally be characterized by a certain degree of sequence identity to the reference module from which it is derived. Thus, the module C variant has a sequence identity of at least 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99% or even 99.9% to the respective reference module C. Preferably, the sequence identity is over a continuous stretch of at least 5, 10, 15, 18, 20, 24, 27, 28, 30, 34 or more amino acids, preferably over the whole length of the respective reference module C.

The sequence identity may be at least 80% over the whole length, may be at least 85% over the whole length, may be at least 90% over the whole length, may be at least 95% over the whole length, may be at least 98% over the whole length, or may be at least 99% over the whole length of the respective reference module C. Alternatively, the sequence identity may be at least 80% over a continuous stretch of at least 5, 10, 15, 18, 20, 24, 28, or 30 amino acids, may be at least 85% over a continuous stretch of at least 5, 10, 15, 18, 20, 24, 28, or 30 amino acids, may be at least 90% over a continuous stretch of at least 5, 10, 15, 18, 20, 24, 28, or 30 amino acids, may be at least 95% over a continuous stretch of at least 5, 10, 15, 18, 20, 24, 28, or 30 amino acids, may be at least 98% over a continuous stretch of at least 5, 10, 15, 18, 20, 24, 28, or 30 amino acids, or may be at least 99% over a continuous stretch of at least 5, 10, 15, 18, 20, 24, 28, or 30 amino acids of the respective reference module C.

A fragment (or deletion) variant of module C has preferably a deletion of up to 1, 2, 3, 4, 5, 6, 7, 8, 9, 10, 11, 12, 13, 14, or 15 amino acids at its N-terminus and/or at its C-terminus. The deletion can also be internally.

Additionally, the module C variant or fragment is only regarded as a module C variant or fragment within the context of the present invention if the modifications with respect to the amino acid sequence on which the variant or fragment is based do not negatively affect the ability of the silk polypeptide to treat dishware in a dishwasher. The skilled person can readily assess whether the silk polypeptide comprising a module C variant or fragment is still capable of treating dishware. In this respect, it is referred to the examples comprised in the experimental part of the present patent application.

C^{Cys} or C^{Lys} variants may also be encompassed by the present invention. Regarding the C^{Cys} or C^{Lys} variants, the same explanations/definitions apply which have been made with respect to the module C variant (see above).

It is still even more preferred that the silk polypeptide is selected from the group consisting of (C)ₘ, (C)ₘC^{Cys} (C)ₘC^{Lys}, C^{Cys} (C)ₘ, C^{Lys} (C)ₘ, (C^{Cys})ₘ and (C^{Lys})ₘ, wherein m is an integer of 1 to 96.

It is most preferred that the silk polypeptide is selected from the group consisting of C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C₂₂, C₂₃, C₂₄, C₂₅, C₂₆, C₂₇, C₂₈, C₂₉, C₃₀, C₃₁, C₃₂, C₃₃, C₃₄, C₃₅, C₃₆, C₃₇, C₃₈, C₃₂, C₃₉, C₄₀, C₄₁, C₄₂, C₄₃, C₄₄, C₄₅, C₄₆, C₄₇, C₄₈,
(C)₁C^{Cys}, (C)₂C^{Cys}, (C)₃C^{Cys}, (C)₄C^{Cys}, (C)₅C^{Cys}, (C)₆C^{Cys}, (C)₇C^{Cys}, (C)₈C^{Cys}, (C)₉C^{Cys}, (C)₁₀C^{Cys}, (C)₁₁C^{Cys}, (C)₁₂C^{Cys}, (C)₁₃C^{Cys}, (C)₁₄C^{Cys}, (C)₁₅C^{Cys}, (C)₁₆C^{Cys}, (C)₁₇C^{Cys}, (C)₁₈C^{Cys}, (C)₁₉C^{Cys}, (C)₂₀C^{Cys}, (C)₂₁C^{Cys}, (C)₂₂C^{Cys}, (C)₂₃C^{Cys}, (C)₂₄C^{Cys}, (C)₂₅C^{Cys}, (C)₂₆C^{Cys}, (C)₂₇C^{Cys}, (C)₂₈C^{Cys}, (C)₂₉C^{Cys}, (C)₃₀C^{Cys}, (C)₃₁C^{Cys}, (C)₃₂C^{Cys}, (C)₃₃C^{Cys}, (C)₃₄C^{Cys}, (C)₃₅C^{Cys}, (C)₃₆C^{Cys}, (C)₃₇C^{Cys}, (C)₃₈C^{Cys}, (C)₃₂C^{Cys}, (C)₃₉C^{Cys}, (C)₄₀C^{Cys}, (C)₄₁C^{Cys}, (C)₄₂C^{Cys}, (C)₄₃C^{Cys}, (C)₄C^{Cys}, (C)₄₅C^{Cys}, (C)₄₆C^{Cys}, (C)₄₇C^{Cys}, (C)₄₈C^{Cys},
(C)₁C^{Lys}, (C)₂C^{Lys}, (C)₃C^{Lys}, (C)₄C^{Lys}, (C)₅C^{Lys}, (C)₆C^{Lys}, (C)₇C^{Lys}, (C)₈C^{Lys}, (C)₉C^{Lys} (C)₁₀C^{Lys}, (C)₁₁C^{Lys}, (C)₁₂C^{Lys}, (C)₁₃C^{Lys}, (C)₁₄C^{Lys}, (C)₁₅C^{Lys}, (C)₁₆C^{Lys}, (C)₁₇C^{Lys}, (C)₁₈C^{Lys}, (C)₁₉C^{Lys}, (C)₂₀C^{Lys}, (C)₂₁C^{Lys}, (C)₂₂C^{Lys}, (C)₂₃C^{Lys}, (C)₂₄C^{Lys}, (C)₂₅C^{Lys}, (C)₂₆C^{Lys}, (C)₂₇C^{Lys}, (C)₂₈C^{Lys}, (C)₂₉C^{Lys}, (C)₃₀C^{Lys}, (C)₃₁C^{Lys}, (C)₃₂C^{Lys}, (C)₃₃C^{Lys}, (C)₃₄C^{Lys}, (C)₃₅C^{Lys}, (C)₃₆C^{Lys}, (C)₃₇C^{Lys}, (C)₃₈C^{Lys}, (C)₃₂C^{Lys}, (C)₃₉C^{Lys}, (C)₄₀C^{Lys}, (C)₄₁C^{Lys}, (C)₄₂C^{Lys}, (C)₄₃C^{Lys}, (C)₄₄C^{Lys}, (C)₄₅C^{Lys}, (C)₄₆C^{Lys}, (C)₄₇C^{Lys}, (C)₄₈C^{Lys},
C^{Cys}(C)₁, C^{Cys}(C)₂, C^{Cys}(C)₃, C^{Cys}(C)₄, C^{Cys}(C)₅, C^{Cys}(C)₆, C^{Cys}(C)₇, C^{Cys}(C)₈, C^{Cys}(C)₉, C^{Cys}(C)₁₀, C^{Cys}(C)₁₁, C^{Cys}(C)₁₂, C^{Cys}(C)₁₃, C^{Cys}(C)₁₄, C^{Cys}(C)₁₅, C^{Cys}(C)₁₆, C^{Cys}(C)₁₇, C^{Cys}(C)₁₈, C^{Cys}(C)₁₉, C^{Cys}(C)₂₀, C^{Cys}(C)₂₁, C^{Cys}(C)₂₂, C^{Cys}(C)₂₃, C^{Cys}(C)₂₄, C^{Cys}(C)₂₅, C^{Cys}(C)₂₆, C^{Cys}(C)₂₇, C^{Cys}(C)₂₈, C^{Cys}(C)₂₉, C^{Cys}(C)₃₀, C^{Cys}(C)₃₁, C^{Cys}(C)₃₂, C^{Cys}(C)₃₃, C^{Cys}(C)₃₄, C^{Cys}(C)₃₅, C^{Cys}(C)₃₆, C^{Cys}(C)₃₇, C^{Cys}(C)₃₈, C^{Cys}(C)₃₉, C^{Cys}(C)₄₀, C^{Cys}(C)₄₁, C^{Cys}(C)₄₂, C^{Cys}(C)₄₃, C^{Cys}(C)₄₄, C^{Cys}(C)₄₅, C^{Cys}(C)₄₆, C^{Cys}(C)₄₇, C^{Cys}(C)₄₈,
C^{Lys}(C)₁, C^{Lys}(C)₂, C^{Lys}(C)₃, C^{Lys}(C)₄, C^{Lys}(C)₅, C^{Lys}(C)₆, C^{Lys}(C)₇, C^{Lys}(C)₈, C^{Lys}(C)₉, C^{Lys}(C)₁₀, C^{Lys}(C)₁₁, C^{Lys}(C)₁₂, C^{Lys}(C)₁₃, C^{Lys}(C)₁₄, C^{Lys}(C)₁₅, C^{Lys}(C)₁₆, C^{Lys}(C)₁₇, C^{Lys}(C)₁₈, C^{Lys}(C)₁₉, C^{Lys}(C)₂₀, C^{Lys}(C)₂₁, C^{Lys}(C)₂₂, C^{Lys}(C)₂₃, C^{Lys}(C)₂₄, C^{Lys}(C)₂₅, C^{Lys}(C)₂₆, C^{Lys}(C)₂₇, C^{Lys}(C)₂₈, C^{Lys}(C)₂₉, C^{Lys}(C)₃₀, C^{Lys}(C)₃₁, C^{Lys}(C)₃₂, C^{Lys}(C)₃₃,

C^{Lys}(C)₃₄, C^{Lys}(C)₃₅, C^{Lys}(C)₃₆, C^{Lys}(C)₃₇, C^{Lys}(C)₃₈, C^{Lys}(C)₃₉, C^{Lys}(C)₄₀, C^{Lys}(C)₄₁, C^{Lys}(C)₄₂, C^{Lys}(C)₄₃, C^{Lys}(C)₄₄, C^{Lys}(C)₄₅, C^{Lys}(C)₄₆, C^{Lys}(C)₄₇ and C^{Lys}(C)₄₈.

In one embodiment, the silk polypeptide comprises an amino terminal TAG, e.g. consisting of the amino acid sequence MASMTGGQQMG (SEQ ID NO: 4). In another embodiment, the silk polypeptide comprises an amino terminal TAG and a Linker, the Linker e.g. consisting of the amino acid sequence RGSM (SEQ ID NO: 5).

In one example, the silk polypeptide comprises 16 times module C (=C₁₆) and has the amino acid sequence according to SEQ ID NO: 6 (with a TAG according to SEQ ID NO: 4 and a Linker according to SEQ ID NO: 5 at the N-terminus).

In another example, the silk polypeptide comprises 16 C^{Lys} modules (C^{Lys}₁₆) (SEQ ID NO: 7).

In another example, the silk polypeptide comprises 17 modules, wherein the first module (N-terminal) or the last module (C-terminal) is a C^{Cys} module (SEQ ID NO: 2) and the 16 other modules are C modules (SEQ ID NO: 1). A specific example is (C)₁₆C^{Cys} (SEQ ID NO: 8)

In another example, the silk polypeptide comprises 17 modules, wherein the first module (N-terminal) or the last module (C-terminal) is a C^{Lys} module (SEQ ID NO: 3) and the 16 other modules are C modules (SEQ ID NO: 1).

Exemplarily larger silk polypeptides based on C modules are the silk polypeptide C₃₂ (32 times module C) having the amino acid sequence according to SEQ ID NO: 9 and the silk polypeptide C₄₈ (48 times module C) having the amino acid sequence according to SEQ ID NO: 10.

Particularly, the above-described silk polypeptide consists exclusively of repetitive units. In other words, the silk polypeptide particularly does not comprise/is free of non-repetitive units. The only component that can additionally be present as part of the silk polypeptide is a tag or moiety, e.g. allowing easy transcription of said silk polypeptide in expression systems and/or allowing easy isolation of said silk polypeptide from the expression systems. Said tag may be a his tag or a flag tag.

The automatic dishwashing composition according to the invention preferably comprising from 0.0005 to 2.5% by weight, more preferably from 0.001 to 2.0% by weight, in particular from 0.05 to 1.5% by weight, e.g. 0.0005, 0.0006, 0.0007, 0.0008, 0.0009, 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, or 2.5 by weight, based on the total weight of the composition, of at least one structural polypeptide (component a)).

For the formulation of the automatic dishwashing composition the structural polypeptide a) can be employed in solid form, e.g. in the form of a powder. The structural polypeptide a) can also be employed in form of a solution. Preferred solvents are water, at least partly water-miscible organic solvents and mixtures thereof. The structural polypeptide a) can also be employed in form of a gel. The gel form preferably comprises the structural polypeptide in an amount of 0.5 to 30% by weight, more preferably 1 to 20% by weight, e.g. 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 by weight, based on the total weight of the gel.

### Component b) (Builder)

The automatic dishwashing composition according to the invention comprises at least one builder (=component b)).

In the terms of the invention, the term builder also encompasses cobuilder. Builders, which are inter alia also referred to as sequestrants, sequestrating agents, builder materials, complexing agents, chelators, chelating agents, softeners or crystal growth inhibitors, bind alkaline earth metals and other water-soluble metal salts and avoid precipitation of solid crystals on the surfaces of the washed items and the dishwasher. They help to break up soil, disperse soil components, help to detach soil and in some cases themselves have a washing effect. In addition, when they are solid and are used in powder formulations, they keep the powder free-flowing.

The automatic dishwashing composition according to the invention preferably comprises, based on the total weight of the composition, from 1 to 90% by weight, more preferably from 2 to 80% by weight, in particular from 10 to 50% by weight, of at least one builder (component b)).

Suitable builders may be organic or inorganic builders. Examples of suitable classes of builders are polycarboxylic acids and salts thereof, hydroxycarboxylic acids and salts thereof, phosphonic acids and salts thereof, e.g. hydroxyalkylphosphonic acids and salts thereof, aminopolycarboxylic acids and salts thereof, polymeric compounds containing carboxylic acid groups and salts thereof, aluminosilicates, inorganic carbonates, phosphates and polyphosphates, and mixtures thereof.

Suitable organic builders are, for example, C₄-C₃₀-di-, -tri- and -tetracarboxylic acids, for example succinic acid, propanetricarboxylic acid, butanetetracarboxylic acid, cyclopentanetetracarboxylic acid, and alkyl- and alkenylsuccinic acids having C₂-C₂₀-alkyl or -alkenyl radicals.

Suitable organic builders are also hydroxycarboxylic acids and polyhydroxycarboxylic acids (sugar acids). These include C₄-C₂₀-hydroxycarboxylic acids, for example malic acid, tartaric acid, gluconic acid, mucic acid, lactic acid, glutaric acid, citric acid, tartronic acid, glucoheptonic acid, lactobionic acid, and sucrosemono-, -di- and tricarboxylic acid. Preferred is citric acid and salts thereof. A preferred salt is sodium citrate.

Suitable organic builders are further phosphonic acids, for example hydroxyalkylphosphonic acids, aminophosphonic acids and the salts thereof. These include, for example, phosphonobutanetricarboxylic acid, aminotris(methylenephosphonic acid) (ATMP), ethylenediamine tetramethylenephosphonic acid (EDTMP), hexamethylene-diamine tetramethylenephosphonic acid (HDTMP), diethylenetriamine-pentamethylenephosphonic acid (DTPMP), morpholinomethanediphosphonic acid, 1-hydroxyethane-1,1-diphosphonic acid (HEDP) and mixtures thereof. Preferred is 1-hydroxyethane-1,1-diphosphonic acid and salts thereof.

Suitable organic builders are further aminopolycarboxylic acids, such as nitrilotriacetic acid (NTA), nitrilomonoacetic dipropionic acid, nitrilotripropionic acid, β-alaninediacetic acid (β-ADA), ethylenediaminetetraacetic acid (EDTA), diethylenetriaminepentaacetic acid, 1,3-propylenediaminetetraacetic acid, 1,2-propylenediaminetetraacetic acid, N-(alkyl)ethylenediaminetriacetic acid, N (hydroxyalkyl)ethylenediaminetriacetic acid, ethylenediaminetriacetic acid, cyclohexylene-1,2-diaminetetraacetic acid, iminodisuccinic acid, ethylenediaminedisuccinic acid, serinediacetic acid, isoserinediacetic acid, L-asparaginediacetic acid, L-glutaminediacetic acid (GLDA), methylglycinediacetic acid (MGDA), and the salts of the aforementioned aminopolycarboxylic acids, and mixtures thereof. Preferred are ethylenediaminetetraacetic acid (EDTA) and salts thereof, L-glutaminediacetic acid (GLDA) and salts thereof, methylglycinediacetic acid (MGDA) and salts thereof, and mixtures thereof.

Suitable organic builders are further polymeric compounds containing carboxylic acid groups. An example are acrylic acid homo- and copolymers and the salts thereof. Acrylic acid homopolymers preferably have a number-average molecular weight in the range from 800 to 70 000 g/mol, more preferably from 900 to 50 000 g/mol, particularly from 1000 to 20 000 g/mol, especially 1000 to 10 000 g/mol. The term “acrylic acid homopolymer” also comprises polymers in which some or all of the carboxylic acid groups are in neutralized form. These include acrylic acid homopolymers in which some or all of the carboxylic acid groups are in the form of alkali metal salts or ammonium salts. Preference is given to acrylic acid homopolymers in which the carboxylic acid groups are protonated or in which some or all of the carboxylic acid groups are in the form of sodium salts.

Suitable organic builders are further oligomaleic acids and the salts thereof. Suitable organic builders are further terpolymers of unsaturated C₄-C₈-dicarboxylic acids, where the polymerized comonomers may include monoethylenically unsaturated monomers from group (i) specified below in amounts of up to 95% by weight, from group (ii) in amounts of up to 60% by weight and from group (iii) in amounts of up to 20% by weight. Suitable unsaturated C₄-C₈-dicarboxylic acids in this context are, for example, maleic acid, fumaric acid, itaconic acid and citraconic acid. Group (i) comprises monoethylenically unsaturated C₃-C₈-monocarboxylic acids, for example acrylic acid, methacrylic acid, crotonic acid and vinylacetic acid. From group (i), preference is given to using acrylic acid and methacrylic acid. Group (ii) comprises monoethylenically unsaturated C₂-C₂₂-olefins, vinyl alkyl ethers having C₁-C₈-alkyl groups, styrene, vinyl esters of C₁-C₈-carboxylic acids, (meth)acrylamide and vinylpyrrolidone. From group (ii), preference is given to using C₂-C₆-olefins, vinyl alkyl ethers having C₁-C₄-alkyl groups, vinyl acetate and vinyl propionate. If the polymers of group (ii) comprise vinyl esters in polymerized form, they may also be present partly or fully hydrolyzed to vinyl alcohol structural units. Group (iii) comprises (meth)acrylic esters of C₁-C₆ alcohols, (meth)acrylonitrile, (meth)acrylamides of C₁-C₈ amines, N-vinylformamide and N-vinylimidazole.

Suitable organic builders are further homopolymers of monoethylenically unsaturated C₃-C₈-monocarboxylic acids, for example acrylic acid, methacrylic acid, crotonic acid and vinylacetic acid, especially of acrylic acid and methacrylic acid, copolymers of dicarboxylic acids, for example copolymers of maleic acid and acrylic acid in a weight ratio of 10:90 to 95:5, more preferably those in a weight ratio of from 30:70 to 90:10 with molar masses of from 1000 to 150 000; copolymers of itaconic acid and acrylic acid in a weight ratio of 10:90 to 95:5; terpolymers of maleic acid, acrylic acid and a vinyl ester of a C₁-C₃-carboxylic acid in a weight ratio of from 10 (maleic acid):90 (acrylic acid+vinyl ester) to 95 (maleic acid): 10 (acrylic acid+vinyl ester), where the weight ratio of acrylic acid to the vinyl ester may vary within the range from 30:70 to 70:30; copolymers of maleic acid with C₂-C₈-olefins in a molar ratio of from 40:60 to 80:20, particular preference being given to copolymers of maleic acid with ethylene, propylene or isobutene in a molar ratio of 50:50.

Suitable organic builders are further copolymers of 50% to 98% by weight of ethylenically unsaturated weak carboxylic acids with 2% to 50% by weight of ethylenically unsaturated sulfonic acids. Suitable weak ethylenically unsaturated carboxylic acids are especially C₃-C₆-monocarboxylic acids, such as acrylic acid and methacrylic acid. Suitable ethylenically unsaturated sulfonic acids are 2-acrylamido-2-methyl-1-propane sulfonic acid (AMPS), 2-methacrylamido-2-methyl-1-propanesulfonic acid, 2-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy) propanesulfonic acid, 2-methyl-2-propene-1-sulfonic acid, styrenesulfonic acid, vinylsulfonic acid, 3-sulfopropyl acrylate, 3-sulfopropyl methacrylate and salts of these acids. The copolymers may also comprise, in copolymerized form, 0 to 30% by weight of ethylenically unsaturated C₄-C₈-dicarboxylic acids, such as maleic acid, and 0 to 30% by weight of at least one monomer which is copolymerizable with the aforementioned monomers. The latter are, for example, C₁-C₄-alkyl esters of (meth)acrylic acid, C₁-C₄-hydroxyalkyl esters of (meth)acrylic acid, acrylamide, alkyl-substituted acrylamide. N,N-dialkyl-substituted acrylamide, vinylphosphonic acid, vinyl acetate, allyl alcohols, sulfonated allyl alcohols, styrene and other vinylaromatics, acrylonitrile, N-vinylpyrrolidone, N-vinylformamide, N-vinylimidazole or N-vinylpyridine. The weight-average molecular weight of these copolymers is within the range from 3000 to 50 000 daltons. A preferred embodiment are copolymers of at least one ethylenically unsaturated C₃-C₆-monocarboxylic acid and at least one ethylenically unsaturated sulfonic acid, in particular copolymers of acrylic acid and 2-acrylamido-2-methyl-1-propane sulfonic acid (AMPS) (commercially available under the tradename ACUSOL 588 from Dow Chemical Company). Particularly suitable copolymers are those with about 77% by weight of at least one ethylenically unsaturated C₃-C₆-monocarboxylic acid and about 23% by weight of at least one ethylenically unsaturated sulfonic acid.

Suitable organic builders are further graft polymers of unsaturated carboxylic acids onto low molecular weight carbohydrates or hydrogenated carbohydrates. Suitable unsaturated carboxylic acids in this context are, for example, maleic acid, fumaric acid, itaconic acid, citraconic acid, acrylic acid, methacrylic acid, crotonic acid and vinylacetic acid and also mixtures of acrylic acid and maleic acid, which are grafted on in amounts of 40% to 95% by weight, based on the component to be grafted. It is possible to use up to 30% by weight, based on the component to be grafted, of further monoethylenically unsaturated monomers. Suitable modifying monomers are the abovementioned monomers of groups (ii) and (iii). Suitable graft bases are degraded polysaccharides, for example acidically or enzymatically degraded starches, inulins or cellulose, protein hydrolyzates and reduced (hydrogenated or hydrogenatingly aminated) degraded polysaccharides, for example mannitol, sorbitol, aminosorbitol and N-alkylglucamine, as are polyalkylene glycols with molar masses of up to Mw=5000, for example polyethylene glycols, ethylene oxide/propylene oxide or ethylene oxide/butylene oxide or ethylene oxide/propylene oxide/butylene oxide block copolymers and alkoxylated mono- or polyhydric C₁-C₂₂ alcohols.

Suitable organic builders are further polyglyoxylic acids.

Suitable organic builders are further polyamidocarboxylic acids and modified polyamidocarboxylic acids.

Suitable organic builders are further polyaspartic acids or cocondensates of aspartic acid with further amino acids, C₄-C₂₅ mono-or-dicarboxylic acids and/or C₄-C₂₅ mono- or -diamines. A special embodiment are polyaspartic acids which have been prepared in phosphorus acids and have been modified with C₆-C₂₂ mono-or-dicarboxylic acids or with C₆-C₂₂ mono-or-diamines.

A preferred class of builders are polymeric compounds containing carboxylic acid groups. In particular preferred as builders are polyacrylic acid homo and copolymers that can be in partly or fully neutralized form.

Suitable organic builders are further iminodisuccinic acid, oxydisuccinic acid, aminopolycarboxylates, alkyl polyaminocarboxylates, aminopolyalkylenephosphonates, polyglutamates, hydrophobically modified citric acid, for example agaric acid, poly-α-hydroxyacrylic acid, N-acylethylenediamine triacetates such as lauroylethylenediamine triacetate and alkylamides of ethylenediaminetetraacetic acid, such as EDTA tallow amide.

In a special embodiment, the automatic dishwashing composition comprises a builder b) selected from methyl glycine diacetic acid (MGDA) and the salts thereof, glutamic-N,N-diacetic acid (GLDA) and the salts thereof, iminodisuccinic acid and the salts thereof, ethylenediaminetetraacetic acid (EDTA) and the salts thereof, diethylene triamine pentaacetic acid (DTPA) and the salts thereof, hydroxyethyl ethylene diamine triacetic acid (HEDTA) and the salts thereof, carboxy methyl inulin and the salts thereof, and mixtures of the afore-mentioned builders.

Suitable inorganic builders b) are, for example, crystalline or amorphous aluminosilicates having ion-exchanging properties, such as zeolites. Various types of zeolites are suitable, especially zeolites A, X. B. P. MAP and HS in the sodium form thereof, or in forms in which Na has been partially exchanged for other cations such as Li, K. Ca,

Mg or ammonium. Crystalline silicates suitable as builders are, for example, disilicates or sheet silicates, e.g. 5-Na₂Si₂O₅ or B—Na2Si2O5 (SKS 6 or SKS 7). The silicates can be used in the form of their alkali metal, alkaline earth metal or ammonium salts, preferably as sodium, lithium and magnesium silicates. Amorphous silicates, for example sodium metasilicate which has a polymeric structure, or amorphous disilicate (Britesil® H 20, manufacturer: Akzo), are likewise usable.

Suitable organic builders are further carbonates and hydrogencarbonates. These can be used in the form of their alkali metal, alkaline earth metal or ammonium salts. Preference is given to using sodium, lithium and magnesium carbonates or sodium, lithium and magnesium hydrogencarbonates, especially sodium carbonate and/or sodium hydrogencarbonate.

In a special embodiment, a mixture of different builders is used as component b). The mixture of different builders preferably comprises at least two of the following constituents:
at least one polymeric compound containing carboxylic acid groups or a partly or fully neutralized form thereof (preferably polyacrylic acid or a partly or fully neutralized form thereof),
at least one (poly) hydroxycarboxylic acid or a salt thereof (preferably citric acid or a citrate, in particular sodium citrate),
at least one aminopolycarboxylic acid or a salt thereof, preferably selected from methylglycinediacetic acid (MGDA) and salts thereof, ethylenediaminetetraacetic acid (EDTA) and salts thereof and L-glutaminediacetic acid (GLDA) and salts thereof,
at least one hydroxyalkylphosphonic acid or aminophosphonic acid, preferably 1-hydroxyethane-1-(1,1-diphosphonic acid) (HEDP),
at least on inorganic builder, preferably selected from carbonates, silicates and mixtures thereof.

### Component c) (Enzyme)

The automatic dishwashing composition according to the invention may comprise at least one enzyme (=component c)).

Suitable enzymes are those typically used as industrial enzymes. These include in particular enzymes having optimal activity in the neutral to alkaline pH range.

If the automatic dishwashing composition comprises at least one enzyme, the amount of enzyme protein is preferably at least 0.001% by weight, more preferably at least 0.01% by weight, in particular at least 0.05% by weight, based on the total weight of the composition.

The automatic dishwashing composition according to the invention preferably comprises at least one enzyme in an amount of from 0.001 to 10% by weight, more preferably from 0.005 to 8% by weight, in particular from 0.01 to 5% by weight, enzyme protein based on the total weight of the composition.

Often, enzymes are employed in dishwashing formulations not in form of the pure active enzyme protein but in combination with a carrier and/or in encapsulated form and optionally with further additives. The afore-mentioned amounts refer to the active enzyme protein without any further components.

The enzymes are preferably selected from aminopeptidases, amylases, arabinases, carbohydrases, carboxypeptidases, catalases, cellulases, chitinases, cutinases, cyclodextrin glycosyltransferases, deoxyribonucleases, esterases, galactanases, alpha-galactosidases, beta-galactosidases, glucanases, glucoamylases, alpha-glucosidases, beta-glucosidases, haloperoxidases, hydrolases, invertases, isomerases, keratinases, laccases, lipases, mannanases, mannosidases, oxidases, pectinolytic enzymes, peptidoglutaminases, peroxidases, peroxygenases, phytases, polyphenol oxidases, proteolytic enzymes, ribonucleases, transglutaminases, transferases, xylanases and mixtures thereof.

In particular, the automatic dishwashing composition comprises one or more enzymes selected from amylases, arabinases, carbohydrases, cellulases (e.g. endoglucanases), cutinases, deoxyribonucleases, galactanases, haloperoxygenases, lipases, mannanases, oxidases (e.g. laccases and/or peroxidases), pectinases, pectin lyases, proteases, xylanases, xanthanases, xyloglucanases, oxidoreductase and mixtures thereof. Preferably, the automatic dishwashing composition comprises at least one enzyme selected from amylases, arabinases, carbohydrases, cellulases, galactanases, lipases, mannanases, pectinases, pectin lyases, proteases and mixtures thereof.

In a special embodiment, the automatic dishwashing composition comprises at least one amylase. When the composition comprises at least one amylase and at least one additional enzyme, the additional enzyme is preferably a protease and/or a lipase.

### Proteases

The composition may comprise one or more proteases including those of bacterial, fungal, plant, viral or animal origin. Proteases of microbial origin are preferred. The protease may be an alkaline protease, such as a serine protease or a metalloprotease. A serine protease may for example be of the S1 family, such as trypsin, or the S8 family such as subtilisin. A metalloprotease may for example be a thermolysin from, e.g., family M4 or another metalloprotease such as those from M5, M7 or M8 families.

Examples of metalloproteases are the neutral metalloproteases as described in WO 2007/044993 (Genencor Int.) such as those derived from Bacillus amyloliquefaciens.

Suitable commercially available protease enzymes include those sold under the trade names Alcalase®, Duralase™, Durazym™, Relase®, Relase® Ultra, Savinase®, Savinase® Ultra, Primase®, Polarzyme®, Kannase®, Liquanase®, Liquanase® Ultra, Ovozyme®, Coronase®, Coronase® Ultra, Blaze®, Blaze Evity® 100T, Blaze Evity® 125T, Blaze Evity® 150T, Neutrase®, Everlase®, Esperase®, Progress® Uno and Progress® Excel (Novozymes A/S), those sold under the tradenames Maxatase®, Maxacal®, Maxapem®, Purafect®™, Purafect® Ox, Purafect® OxP, Purafect Prime®, Puramax®, FN2®, FN3®, FN4®, Excellase®, Excellenz P1000™, Excellenz P1250™, Eraser®, Preferenz® P100, Preferenz® P110, Effectenz P1000™, Effectenz P1050™, Effectenz P2000™, Purafast®, Properase®, Opticlean® and Optimase® (Danisco/DuPont), Axapem™ (Gist-Brocases N.V.), BLAP (sequence shown in FIG. 29 of U.S. Pat. No. 5,352,604) and variants hereof (Henkel AG) and KAP (Bacillus alkalophilus subtilisin) from Kao.

### Lipases and Cutinases

Suitable lipases and cutinases include those of bacterial or fungal origin, including chemically modified or protein engineered mutant enzymes. Examples include lipase from Thermomyces, e.g., from T. lanuginosus (previously named Humicola lanuginosa) as described in EP 258068 and EP 305216, cutinase from Humicola, e.g., H. insolens (WO 96/13580), lipase from strains of Pseudomonas (some of these now renamed to Burkholderia), e.g., P. alcaligenes or P. pseudoalcaligenes (EP 218272), P. cepacia (EP 331376), P. sp. strain SD705 (WO 95/06720 and WO 96/27002), P. wisconsinensis (WO 96/12012), GDSL-type Streptomyces lipases (WO 2010/065455), cutinase from Magnaporthe grisea (WO 2010/107560), cutinase from Pseudomonas mendocina (U.S. Pat. No. 5,389,536), lipase from Thermobifida fusca (WO 2011/084412), Geobacillus stearothermophilus lipase (WO 2011/084417), lipase from Bacillus subtilis (WO 2011/084599), and lipase from Streptomyces griseus (WO 2011/150157) and S. pristinaespiralis (WO 2012/137147).

Preferred commercial lipase products include Lipolase™, Lipex™; Lipolex™ and Lipoclean™ (Novozymes A/S), Lumafast (originally from Genencor) and Lipomax (originally from Gist-Brocades).

Further suitable are lipases that are referred to as acyltransferases or perhydrolases, e.g., acyltransferases with homology to Candida antarctica lipase A (WO 2010/111143), acyltransferase from Mycobacterium smegmatis (WO 2005/056782), perhydrolases from the CE 7 family (WO 2009/067279), and variants of the M. smegmatis perhydrolase, in particular the S54V variant used in the commercial product Gentle Power Bleach from Huntsman Textile Effects Pte Ltd (WO 2010/100028).

### Amylases

Suitable amylases which can be used together with the protease may be an alpha-amylase or a glucoamylase and may be of bacterial or fungal origin. Chemically modified or protein engineered mutants are included. Amylases include, for example, alpha-amylases obtained from Bacillus, e.g., a special strain of Bacillus licheniformis, described in more detail in GB 1,296,839.

Suitable amylases include amylases having SEQ ID NO: 2 in WO 95/10603 or variants having 90% sequence identity to SEQ ID NO: 3 thereof. Preferred variants are described in WO 94/02597, WO 94/18314, WO 97/43424 and SEQ ID NO: 4 of WO 99/19467, such as variants with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444.

Further suitable amylases include amylases having SEQ ID NO: 6 in WO 02/10355 or variants thereof having 90% sequence identity to SEQ ID NO: 6. Preferred variants of SEQ ID NO: 6 are those having a deletion in positions 181 and 182 and a substitution in position 193.

Further suitable amylases are hybrid alpha-amylases comprising residues 1-33 of the alpha-amylase derived from B. amyloliquefaciens shown in SEQ ID NO: 6 of WO 2006/066594 and residues 36-483 of the B. licheniformis alpha-amylase shown in SEQ ID NO: 4 of WO 2006/066594 or variants having 90% sequence identity thereof. Preferred variants of this hybrid alpha-amylase are those having a substitution, a deletion or an insertion in one of more of the following positions: G48, T49, G107, H156, A181, N190, M197, I201, A209 and Q264. Most preferred variants of the hybrid alpha-amylase comprising residues 1-33 of the alpha-amylase derived from B. amyloliquefaciens shown in SEQ ID NO: 6 of WO 2006/066594 and residues 36-483 of SEQ ID NO: 4 are those having the substitutions:
M 197T;
H156Y+A181T+N190F+A209V+Q264S; or
G48A+T49I+G107A+H156Y+A181T+N190F+I201F+A209V+Q264S.

Further suitable amylases are amylases having the sequence of SEQ ID NO: 6 in WO 99/19467 or variants thereof having 90% sequence identity to SEQ ID NO: 6. Preferred variants of SEQ ID NO: 6 are those having a substitution, a deletion or an insertion in one or more of the following positions: R181, G182, H183, G184, N195, I206, E212, E216 and K269. Particularly preferred amylases are those having deletion in positions R181 and G182, or positions H183 and G184.

Further suitable amylases which can be used are those having SEQ ID NO: 1, SEQ ID NO: 3, SEQ ID NO: 2 or SEQ ID NO: 7 of WO 96/23873 or variants thereof having 90% sequence identity to SEQ ID NO: 1, SEQ ID NO: 2, SEQ ID NO: 3 or SEQ ID NO: 7. Preferred variants of SEQ ID NO: 1, SEQ ID NO: 2, SEQ ID NO: 3 or SEQ ID NO: 7 are those having a substitution, a deletion or an insertion in one or more of the following positions: 140, 181, 182, 183, 184, 195, 206, 212, 243, 260, 269, 304 and 476, using SEQ ID 2 of WO 96/23873 for numbering. More preferred variants are those having a deletion in two positions selected from 181, 182, 183 and 184, such as 181 and 182, 182 and 183, or positions 183 and 184. Most preferred amylase variants of SEQ ID NO: 1, SEQ ID NO: 2 or SEQ ID NO: 7 are those having a deletion in positions 183 and 184 and a substitution in one or more of positions 140, 195, 206, 243, 260, 304 and 476.

Further suitable amylases which can be used are amylases having SEQ ID NO: 2 of WO 2008/153815, SEQ ID NO: 10 in WO 01/66712 or variants thereof having 90% sequence identity to SEQ ID NO: 2 of WO 2008/153815 or 90% sequence identity to SEQ ID NO: 10 in WO 01/66712. Preferred variants of SEQ ID NO: 10 in WO 01/66712 are those having a substitution, a deletion or an insertion in one of more of the following positions: 176, 177, 178, 179, 190, 201, 207, 211 and 264.

Further suitable amylases are amylases having SEQ ID NO: 2 of WO 2009/061380 or variants having 90% sequence identity to SEQ ID NO: 2 thereof. Preferred variants of SEQ ID NO: 2 are those having a truncation of the C-terminus and/or a substitution, a deletion or an insertion in one of more of the following positions: Q87, Q98, S125, N128, T131, T165, K178, R180, S181, T182, G183, M201, F202, N225, S243, N272, N282, Y305, R309, D319, Q320, Q359, K444 and G475. More preferred variants of SEQ ID NO: 2 are those having the substitution in one of more of the following positions: Q87E,R, Q98R, S125A, N128C, T131I, T165I, K178L, T182G, M201L, F202Y, N225E,R, N272E,R, S243Q,A,E,D, Y305R, R309A, Q320R, Q359E, K444E and G475K and/or deletion in position R180 and/or S181 or of T182 and/or G183. Most preferred amylase variants of SEQ ID NO: 2 are those having the substitutions:
N128C+K178L+T182G+Y305R+G475K;
N128C+K178L+T182G+F202Y+Y305R+D319T+G475K;
S125A+N128C+K178L+T182G+Y305R+G475K; or
S125A+N128C+T131I+T165I+K178L+T182G+Y305R+G475K,
   wherein the variants are C-terminally truncated and optionally further comprise a substitution at position 243 and/or a deletion at position 180 and/or position 181.

Further suitable amylases are amylases having SEQ ID NO: 1 of WO 2013/184577 or variants having 90% sequence identity to SEQ ID NO: 1 thereof. Preferred variants of SEQ ID NO: 1 are those having a substitution, a deletion or an insertion in one of more of the following positions: K176, R178, G179, T180, G181, E187, N192, M199, I203, S241, R458, T459, D460, G476 and G477. More preferred variants of SEQ ID NO: 1 are those having the substitution in one of more of the following positions: K176L, E187P, N192FYH, M199L, I203YF, S241QADN, R458N, T459S, D460T, G476K and G477K and/or a deletion in position R178 and/or S179 or of T180 and/or G181. Most preferred amylase variants of SEQ ID NO: 1 comprise the substitutions:
E187P+1203Y+G476K
E187P+I203Y+R458N+T459S+D460T+G476K
   and optionally further comprise a substitution at position 241 and/or a deletion at position 178 and/or position 179.

Further suitable amylases are amylases having SEQ ID NO: 1 of WO 2010/104675 or variants having 90% sequence identity to SEQ ID NO: 1 thereof. Preferred variants of SEQ ID NO: 1 are those having a substitution, a deletion or an insertion in one of more of the following positions: N21, D97, V128 K177, R179, S180, I181, G182, M200, L204, E242, G477 and G478.

Further suitable amylases are the alpha-amylase having SEQ ID NO: 12 in WO 01/66712 or a variant having at least 90% sequence identity to SEQ ID NO: 12. Preferred amylase variants are those having a substitution, a deletion or an insertion in one of more of the following positions of SEQ ID NO: 12 in WO 01/66712: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484. Particularly preferred amylases include variants having a deletion of D183 and G184 and having the substitutions R118K, N195F, R320K and R458K, and a variant additionally having substitutions in one or more position selected from the group: M9, G149, G182, G186, M202, T257, Y295, N299, M323, E345 and A339, most preferred a variant that additionally has substitutions in all these positions.

Suitable commercially available amylases include Duramyl™, Termamyl™, Fungamyl™, Stainzyme™, Stainzyme Plus™, Natalase™, Liquozyme X, BAN™, Amplify® and Amplify® Prime (from Novozymes A/S), and Rapidase™, Purastar™/Effectenz™, Powerase, Preferenz S1000, Preferenz S100 and Preferenz S110 (from Genencor International Inc./DuPont).

### Deoxyribonucleases (DNases)

Suitable deoxyribonucleases (DNases) are any enzyme that catalyzes the hydrolytic cleavage of phosphodiester linkages in the DNA backbone, thus degrading DNA. A DNase which is obtainable from a bacterium is preferred, in particular a DNase which is obtainable from a species of Bacillus is preferred; in particular a DNase which is obtainable from Bacillus subtilis or Bacillus licheniformis is preferred. Examples of such DNases are described in WO 2011/098579 and WO 2014/087011.

### Oxidoreductases

In one embodiment, the composition may comprise an oxidoreductase, which are enzymes that catalyze reduction-oxidation reactions. A preferred oxidoreductase is a superoxide dismutase.

The enzymes can be formulated as a separate component of the automatic dishwashing composition. It can be contained e.g. in a separate compartment of a multicompartment formulation or can be used in the form of an enzyme-containing film.

The automatic dishwashing composition preferably comprises at least one protease and/or amylase.

In a special embodiment, at least one enzyme mixture. Preference is given, for example, to enzyme mixtures comprising or consisting of the following enzymes:
protease and amylase,
protease and lipase (or lipolytic enzymes),
protease and cellulase,
amylase, cellulase and lipase (or lipolytic enzymes),
protease, amylase and lipase (or lipolytic enzymes),
protease, lipase (or lipolytic enzymes) and cellulase.

The enzymes may be adsorbed on carrier substances in order to protect them from premature breakdown. Optionally, the automatic dishwashing composition may also comprise enzyme stabilizers, Examples of these include calcium propionate, sodium formate, boric acids, boronic acids and salts thereof, such as 4-formylphenylboronic acid, peptides and peptide derivatives, for example peptide aldehydes, polyols such as propane-1,2-diol, and mixtures thereof.

### Component d) (Bleaches)

In the senses of the present application, the term bleach denotes also bleach systems that possibly also comprise bleach activators, bleach catalysts and/or bleach stabilizers.

The automatic dishwashing composition according to the invention preferably comprises from 0 to 30% by weight, more preferably from 0 to 25% by weight, based on the total weight of the composition, of at least one bleach (component d)). If the automatic dishwashing composition comprises at least one bleach, then the amount is at least from 0.5% by weight, more preferably at least 1% by weight, based on the total weight of the composition. If the bleach comprises more than one component, the aforementioned amounts refer to the sum of all components of the bleach system.

Suitable bleaches are, for example, percarboxylic acids, for example diperoxododecanedicarboxylic acid, phthalimidopercaproic acid or monoperoxophthalic acid or-terephthalic acid, salts of percarboxylic acids, for example sodium percarbonate, adducts of hydrogen peroxide onto inorganic salts, for example sodium perborate monohydrate, sodium perborate tetrahydrate, sodium carbonate perhydrate or sodium phosphate perhydrate, adducts of hydrogen peroxide onto organic compounds, for example urea perhydrate, or of inorganic peroxo salts, for example alkali metal persulfates or peroxodisulfates.

Suitable bleach activators are, for example, polyacylated sugars, e.g. pentaacetylglucose; acyloxybenzenesulfonic acids and their alkali metal and alkaline earth metal salts, e.g. sodium p-nonanoyloxybenzenesulfonate or sodium p-benzoyloxybenzenesulfonate; N,N-diacylated and N,N,N′,Ni-tetraacylated amines, e.g. N,N,N′,N′-tetraacetylmethylenediamine and -ethylenediamine (TAED), N,N-diacetylaniline, N,N-diacetyl-p-toluidine or 1,3-diacylated hydantoins such as 1,3-diacetyl-5,5-dimethylhydantoin; N-alkyl-N-sulfonylcarbonamides, e.g. N-methyl-N-mesylacetamide or N-methyl-N-mesylbenzamide; N-acylated cyclic hydrazides, acylated triazoles or urazoles, e.g. monoacetylmaleic hydrazide; O,N,N-trisubstituted hydroxylamines, e.g. O-benzoyl-N,N-succinylhydroxylamine, O-acetyl-N,N-succinylhydroxylamine or O,N,N-triacetylhydroxylamine; N,N′-diacylsulfurylamides, e.g. N,N′-dimethyl-N,N′-diacetylsulfurylamide or N,N′-diethyl-N,N′-dipropionylsulfurylamide; acylated lactams, for example acetylcaprolactam, octanoylcaprolactam, benzoylcaprolactam or carbonylbiscaprolactam; anthranil derivatives, for example 2-methylanthranil or 2-phenylanthranil; triacyl cyanurates, e.g. triacetyl cyanurate or tribenzoyl cyanurate; oxime esters and bisoxime esters, for example O-acetylacetone oxime or bisisopropyl iminocarbonate; carboxylic anhydrides, e.g. acetic anhydride, benzoic anhydride, m-chlorobenzoic anhydride or phthalic anhydride; enol esters, for example isopropenyl acetate; 1,3-diacyl-4,5-diacyloxyimidazolines, e. 1,3-diacetyl-4,5-diacetoxyimidazoline; tetraacetylglycoluril and tetrapropionylglycoluril; diacylated 2,5-diketopiperazines, e.g. 1,4-diacetyl-2,5-diketopiperazine; ammonium-substituted nitriles, for example N-methylmorpholinioacetonitrile methylsulfate; acylation products of propylenediurea and 2,2-dimethylpropylenediurea, e.g. tetraacetylpropylenediurea; α-acyloxypolyacylmalonamides, e.g. α-acetoxy-N,N′-diacetylmalonamide; diacyldioxohexahydro-1,3,5-triazines, e.g. 1,5-diacetyl-2,4-dioxohexahydro-1,3,5-triazine; benz-(4H)-1,3-oxazin-4-ones with alkyl radicals, e.g. methyl, or aromatic radicals, e.g. phenyl, in the 2 position.

A bleach system composed of bleaches and bleach activators may optionally also comprise bleach catalysts. Suitable bleach catalysts are, for example, quaternized imines and sulfonimines, described, for example, in U.S. Pat. No. 5,360,569 and EP-A-453003. Particularly effective bleach catalysts are manganese complexes, described, for example, in WO 94/21777. In addition to the described bleach system composed of bleaches, bleach activators and optionally bleach catalysts, it is also possible to use systems with enzymatic peroxide release.

### Component e) (Rheology Modifier)

In order to impart the desired viscosity to automatic dishwashing compositions containing a liquid and especially water, it is possible to use at least one rheology modifier (=component e)). In the context of this application, the terms “rheology modifier” and “thickener” are used synonymously.

The automatic dishwashing composition according to the invention preferably comprises from 0 to 10% by weight, more preferably from 0 to 8% by weight, in particular from 0 to 6% by weight, based on the total weight of the composition, of at least one rheology modifier (component e)). If the automatic dishwashing composition comprises at least one bleach, then the amount is at least 0.1% by weight, more preferably at least 0.3% by weight, based on the total weight of the composition.

In principle, any known rheology modifiers (thickeners) are suitable, provided that they do not exert any adverse effect on the action of the dishwashing composition.

Suitable thickeners may be of natural origin or synthetic in nature.

Examples of thickeners of natural origin are xanthan, carob seed flour, guar flour, carrageenan, agar, tragacanth, gum arabic, alginates, modified starches such as hydroxyethyl starch, starch phosphate esters or starch acetates, dextrins, pectins, and cellulose derivatives such as carboxymethyl cellulose, hydroxyethyl cellulose, hydroxypropyl cellulose, hydroxypropylmethyl cellulose, methyl cellulose and the like.

Thickeners of natural origin are also inorganic thickeners, such as polysilicic acids and clay minerals, e.g. sheet silicates, and the silicates specified for the builders b).

Examples of synthetic thickeners are polyacrylic and polymethacrylic compounds, such as (partly) crosslinked homopolymers of acrylic acid, for example with an allyl ether of sucrose or pentaerythritol or homopolymers of acrylic acid crosslinked with propylene (Carbomer), for example the Carbopol® products from Lubrizol or the Polygel® products from 3V Sigma, copolymers of ethylenically unsaturated mono- or dicarboxylic acids, for example terpolymers of acrylic acid, methacrylic acid or maleic acid with methyl or ethyl acrylate and a (meth)acrylate which is derived from long-chain ethoxylated alcohols, for example the Acusol® products from Dow, copolymers of two or more monomers, which are selected from acrylic acid, methacrylic acid and their C₁-C₄-alkyl esters, for example copolymers of methacrylic acid, butyl acrylate and methyl methacrylate or of butyl acrylate and methyl methacrylate, for example the Aculyn® and Acusol® products from Dow, or crosslinked high molecular weight acrylic acid copolymers, for example copolymers, crosslinked with an allyl ether of sucrose or pentaerythritol, of C₁₀-C₃₀-alkyl acrylates with one or more comonomers which are selected from acrylic acid, methacrylic acid and their C₁-C₄-alkyl esters.

Suitable synthetic thickeners are also reaction products of maleic acid polymers with ethoxylated long-chain alcohols, polyethylene glycols, polyamides, polyimines and polycarboxylic acids.

Mixtures of two or more of the abovementioned thickeners are also suitable.

Preferred thickeners are xanthans and the abovementioned polyacrylic and polymethacrylic compounds.

### Further Additives (Component f))

The automatic dishwashing composition may comprise at least one further additive as additive f). The additive f) is preferably selected from surfactants, bases, corrosion inhibitors, defoamers, dyes, fragrances, fillers, tableting aids, disintegrants, solubilizers, organic solvents, electrolytes, optical brighteners, hydrotropes, antiredeposition agents, antimicrobial ingredients, antioxidants, and mixtures thereof.

Suitable for the automatic dishwashing composition of the invention are in principle the typical additives known to a person skilled in the art. In the following suitable and preferred embodiments for some of the additives are defined in detail.

The automatic dishwashing composition according to the invention preferably comprises from 0 to 90% by weight, more preferably from 0 to 80% by weight, based on the total weight of the composition, of at least one additive different from components a) to e) (component e)). This amount refers to the total weight of all additives. In the following individual amounts for single additives are defined.

If the automatic dishwashing composition comprises at least one further additive, then the amount is at least 0.01% by weight, more preferably at least 0.1% by weight, based on the total weight of the composition.

### Surfactants

Suitable surfactants f) are nonionic surfactants, anionic surfactants, cationic surfactants, amphoteric surfactants and mixtures thereof.

In a special embodiment, the automatic dishwashing composition comprises at least one nonionic surfactant. In an even more special embodiment, the automatic dishwashing composition comprises exclusively nonionic surfactants.

In general, nonionic and ionic surfactants having at least one nonpolar group and at least one polar group and comprising a polyether group are suitable.

Suitable nonionic surfactants are surfactants containing polyether groups, preferably selected from alkyl polyoxyalkylene ethers, aryl polyoxyalkylene ethers, alkylaryl polyoxyalkylene ethers, alkoxylated animal and/or vegetable fats and/or oils, fatty amine alkoxylates, fatty acid amide alkoxylates, fatty acid diethanolamide alkoxylates, polyoxyethylene sorbitan fatty acid esters and mixtures thereof.

Suitable nonionic surfactants g) are e.g. surfactants containing polyether groups PE), for example:

alkyl polyoxyalkylene ethers which derive from low molecular weight C₃-C₆ alcohols or from C₇-C₃₀ fatty alcohols. The ether component here may be derived from ethylene oxide units, propylene oxide units, 1,2-butylene oxide units, 1,4-butylene oxide units and random copolymers and block copolymers thereof.

Suitable nonionic surfactants g) are further fatty alcohol alkoxylates and oxo alcohol alkoxylates, such as isotridecyl alcohol polyoxyethylene ethers and oleyl alcohol polyoxyethylene ethers.

Suitable are also polyoxyalkylene ether containing hydroxyl groups and polyoxyalkylene esters. These include, for example, lauryl alcohol polyoxyethylene acetate.

Suitable are also alkylaryl alcohol polyoxyethylene ethers, for example octylphenol polyoxyethylene ethers, alkoxylated animal and/or vegetable fats and/or oils, for example corn oil ethoxylates, castor oil ethoxylates, tallow fat ethoxylates, alkylphenol alkoxylates, for example ethoxylated isooctyl-, octyl- or nonylphenol, tributylphenol polyoxyethylene ether, fatty amine alkoxylates, fatty acid amide and fatty acid diethanolamide alkoxylates, especially ethoxylates thereof, and polyoxyalkylene sorbitan fatty acid esters.

Suitable as surfactants g) are further alkyl polyether sulfates, e.g. sodium dodecyl poly(oxyethylene) sulfate (sodium lauryl ether sulfate, SLES).

Suitable nonionic surfactants g) are further glyceryl esters, for example glyceryl monostearate, sugar surfactants, sorbitol esters, for example sorbitan fatty acid esters (sorbitan monooleate, sorbitan tristearate), polyoxyethylenesorbitan fatty acid esters, alkyl polyglycosides, N-alkylgluconamides, alkyl methyl sulfoxides, alkyldimethylphosphine oxides, for example tetradecyldimethylphosphine oxide.

Suitable anionic surfactants g) are soaps, alkylsulfonates, alkylbenzenesulfonates, olefinsulfonates, methyl ester sulfonates, sulfo fatty acids, alkyl sulfates, mono- and dialkyl sulfosuccinates, mono- and dialkyl sulfosuccinamates, sulfotriglycerides, amide soaps, ether carboxylic acids and salts thereof, fatty acid isethionates, fatty acid sarcosinates, fatty acid taurides, N-acylamino acids, for example acyl lactylates, acyl tartrates, acyl glutamates and acyl aspartates, alkyl oligoglucoside sulfates, alkylglucose carboxylates, protein fatty acid condensates and alkyl (ether) phosphates.

Suitable anionic surfactants g) are also surfactants containing polyether groups, preferably selected from alkyl polyether sulfates, aryl polyether sulfates, alkylaryl polyether sulfates, alkyl polyether sulfonates, aryl polyether sulfonates, alkylaryl polyether sulfonates, alkyl polyether phosphates, aryl polyether phosphates, alkylaryl polyether phosphates, glyceryl ether sulfonates, glyceryl ether sulfates, monoglyceride (ether) sulfates, fatty acid amide ether sulfates and mixtures thereof.

Suitable amphoteric surfactants g) are, for example, alkyl betaines, alkylamidopropyl betaines, alkyl sulfobetaines, alkyl glycinates, alkyl carboxyglycinates, alkyl amphoacetates or alkyl amphopropionates, alkyl amphodiacetates or alkyl amphodipropionates. For example, it is possible to use cocodimethylsulfopropyl betaine, lauryl betaine, cocamidopropyl betaine, sodium cocamphopropionate or tetradecyldimethylamine oxide.

Suitable cationic surfactants g) include, for example, quaternized ammonium compounds, especially alkyltrimethylammonium and dialkyldimethylammonium halides and alkylsulfates, and also pyridine and imidazoline derivatives, especially alkylpyridinium halides. For example, it is possible to use behenyl- or cetyltrimethylammonium chloride.

### Solvents

Suitable organic solvents g) are selected from mono- or polyhydric alcohols, alkanolamines and glycol ethers. The solvents g) are preferably selected from ethanol, n- or isopropanol, butanols, glycol, propanediol, butanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether or dipropylene glycol monoethyl ether, diisopropylene glycol monomethyl ether, diisopropylene glycol monoethyl ether, methoxytriglycol, ethoxytriglycol, butoxytriglycol, butoxyethoxy-2-propanol, 3-methyl-3-methoxy butanol, propylene glycol t-butyl ether and mixtures of these solvents.

### Defoamers/Foam Inhibitors/Suds Suppressors

Useful foam inhibitors (also denoted as defoamers or suds suppressors) f) include, for example, soaps, paraffins or silicone oils, alkyl phosphate esters or combinations thereof.

The automatic dishwashing composition according to the invention preferably comprises from 0 to 10% by weight, more preferably from 0 to 5% by weight, in particular from 0 to 1.5% by weight, based on the total weight of the composition, of at least one defoamer g). If the automatic dishwashing composition comprises at least one defoamer, then the amount is at least 0.0001% by weight, more preferably at least 0.001% by weight, in particular at least 0.01% by weight, based on the total weight of the composition.

Suds suppressors are preferably included in the composition of the invention, especially when the composition comprises anionic surfactant. A preferred silicone based suds suppressors is polydimethylsiloxanes having trimethylsilyl, or alternate end blocking units. These may be compounded with silica and/or with surface-active non-silicon components. A suitable silicone based suds suppressor comprises solid silica, a silicone fluid or a silicone resin. The silicone based suds suppressor can be e.g. in the form of granules or a liquid. Another silicone based suds suppressor comprises dimethylpolysiloxane, a hydrophilic polysiloxane compound having polyethylenoxy-propylenoxy group in the side chain, and a micro-powdery silica.

Suitable as phosphate ester suds suppressor are alkyl phosphate esters containing from 16 to 20 carbon atoms. Such phosphate ester suds suppressors may be monostearyl acid phosphate or monooleyl acid phosphate or salts thereof, preferably alkali metal salts.

### Bases

Suitable bases (also denoted as alkalinity sources or alkalinity reserve) are alkali metal hydroxides, alkaline earth metal hydroxides, alkali metal carbonates, alkaline earth metal carbonates, ammonium carbonate, alkali metal hydrogencarbonates, alkaline earth metal hydrogencarbonates, ammonium hydrogencarbonate, alkali metal silicates and mixtures thereof. The pH value of a cleaning solution of the automatic dishwashing composition according to the invention is typically in the alkaline region, preferably in a range of 7.5 to 12, more preferably, 8.0 to 10.0.

In addition, the automatic dishwashing composition according to the invention may comprise further additives g) which further improve the performance and/or esthetic properties. In order to improve the esthetic impression of the dishwashing compositions of the invention can e.g. be colored with suitable dyes. Preferred dyes, the selection of which presents no difficulty whatsoever to the person skilled in the art, have a high storage stability and insensitivity with respect to the other ingredients of the compositions and to light.

### Hydrotropes

Many current dishwashing formulations contain anionic surfactants that may gel unless prevented by various solvents or hydrotropes. Hydrotropes are viscosity controlling agents, gel suppressants, stability agents and dispersability aids. Commonly used hydrotropes include alcohols and alcohol derivatives including glycols and alkoxylated alcohols. Suitable hydrotropes for use herein include anionic-type hydrotropes, particularly sodium, potassium and ammonium xylene sulfonate, sodium, potassium and ammonium toluene sulfonate, sodium, potassium and ammonium cumene sulfonate, and mixtures thereof, and related compounds. The automatic dishwashing compositions of the invention preferably comprises from 0 to 15% by weight, more preferably from 0.1% to 10% by weight, in particular from 1% to 8% by weight, based on the total weight of the composition, of a hydrotrope.

### Water (Component g))

The automatic dishwashing composition may comprise water. Preferably, the automatic dishwashing composition according to the invention comprises water in an amount from 0 to 90% by weight, more preferably from 0 to 80% by weight, based on the total weight of the composition.

If the automatic dishwashing composition comprises water, then the amount is at least 0.1% by weight, more preferably at least 1.0% by weight, based on the total weight of the composition. Water-containing ADW compositions can be in liquid or in gel form. multicompartment formulations can comprise one or more components that comprise water.

The automatic dishwashing composition preferably comprises:
a) at least one structural polypeptide,
b) at least one builder (also referred to as sequestrant, builder material, complexing agent, chelator, chelating agent, softener or crystal growth inhibitor),
c) optionally at least one enzyme
d) optionally at least one bleach,
e) optionally water,
f) optionally at least one rheology modifier, and
g) optionally at least one further additive different from components a) to f), preferably selected from surfactants, bases, corrosion inhibitors, defoamers, dyes, fragrances, fillers, tableting aids, disintegrants, solubilizers, organic solvents, electrolytes, optical brighteners, hydrotropes, antiredeposition agents, antimicrobial ingredients, antioxidants.

The automatic dishwashing composition preferably comprises, based on the total weight of the composition:
a) 0.0005 to 2.5% by weight, based on the total weight of the composition, of at least one structural polypeptide,
b) 1% to 90% by weight, based on the total weight of the composition, of at least one builder,
c) 0% to 10% by weight (preferably 0.001 to 10% by weight, more preferably 0.005 to 8% by weight, in particular 0.01 to 5% by weight) of at least one enzyme, based on the proportion of enzyme protein in the total weight of the composition,
d) 0% to 30% by weight (preferably at least 0.5% by weight, more preferably at least 1% by weight), based on the total weight of the composition, of at least one bleach component,
e) 0% to 10% by weight (preferably at least 0.1% by weight, more preferably at least 0.3% by weight), based on the total weight of the composition, of at least one rheology modifier,
f) 0% to 90% by weight (preferably at least 0.01% by weight, more preferably at least 0.1% by weight), based on the total weight of the composition, of at least one additive different from components a) to e), preferably selected from surfactants, bases, corrosion inhibitors, defoamers, dyes, fragrances, fillers, tableting aids, disintegrants, solubilizers, organic solvents, electrolytes, optical brighteners, hydrotropes, antiredeposition agents, antimicrobial ingredients, antioxidants and mixtures thereof, and
g) 0% to 90% by weight (preferably at least 0.1% by weight, more preferably at least 1.0% by weight), based on the total weight of the composition, of water,
with the proviso that the weight of components a) to g) adds up to 100% by weight.

The automatic dishwashing composition more preferably comprises, based on the total weight of the composition:
a) 0.001 to 2.0% by weight, based on the total weight of the composition, of at least one structural polypeptide,
b) 2% to 80% by weight, based on the total weight of the composition, of at least one builder,
c) 0% to 8% by weight (preferably 0.001 to 10% by weight, more preferably from 0.005 to 8% by weight, in particular from 0.01 to 5% by weight) of at least one enzyme, based on the proportion of enzyme protein in the total weight of the composition,
d) 0% to 20% by weight (preferably at least 0.5% by weight, more preferably at least 1% by weight), based on the total weight of the composition, of at least one bleach,
e) 0% to 8% by weight (preferably at least 0.1% by weight, more preferably at least 0.3% by weight), based on the total weight of the composition, of at least one rheology modifier,
f) 0% to 80% by weight (preferably at least 0.01% by weight, more preferably at least 0.1% by weight), based on the total weight of the composition, of at least one additive different from components a) to e), preferably selected from surfactants, bases, corrosion inhibitors, defoamers, dyes, fragrances, fillers, tableting aids, disintegrants, solubilizers, organic solvents, electrolytes, optical brighteners, hydrotropes, antiredeposition agents, antimicrobial ingredients, antioxidants and mixtures thereof, and
g) 0% to 90% by weight (preferably at least 0.1% by weight, more preferably at least 1.0% by weight), based on the total weight of the composition, of water,
with the proviso that the weight of components a) to g) adds up to 100% by weight.

A special embodiment of the invention is an automatic dishwashing composition in gel form. In the sense of the invention this means that the composition is in the form of a gel under standard conditions (20° C.). “Gel-like consistency” is shown by formulations which have a higher viscosity than a liquid and which are especially self-supporting, meaning that they retain any shape imparted to them without shape-stabilizing encasement. In contrast to solid formulations, however, formulations in gel form can be deformed or converted to a fluid form easily by heating and/or with application of shear forces. The viscosity of the automatic dishwashing compositions in gel form at 20° C. is preferably within a range from 600 to 10 000 000 mPa·s, more preferably from 1000 to 1 000 000 mPa·s, especially from 2000 to 500 000 mPa·s. Measurement can be affected with a Brookfield viscosimeter at 20° C. Depending upon the magnitude of the viscosity the spindle and rotational speed has to be adapted.

All the embodiments described above for the automatic dishwashing composition may also apply for the hand dishwashing composition, if nothing speaks against it on the professional side. The same applies to all methods and uses described above.

In all aspects/embodiments described above, the structural polypeptide, specifically the silk polypeptide, is preferably present in gel, particularly hydrogel, form in the (automatic/hand) dishwashing composition.

Various modifications and variations of the invention will be apparent to those skilled in the art without departing from the scope of invention. Although the invention has been described in connection with specific preferred embodiments, it should be understood that the invention as claimed should not be unduly limited to such specific embodiments. Indeed, various modifications of the described modes for carrying out the invention which are obvious to those skilled in the art in the relevant fields are intended to be covered by the present invention.

PREFERRED EMBODIMENTS OF THE INVENTION
1. A (n) (automatic/hand) dishwashing composition, comprising:
   a) a structural polypeptide, and
   b) at least one builder.
2. The (automatic/hand) dishwashing composition according to embodiment 1, wherein the structural polypeptide a) is a silk polypeptide.
3. The (automatic/hand) dishwashing composition according to embodiment 2, wherein the silk polypeptide is a recombinant or synthetic silk polypeptide, preferably a spider silk polypeptide.
4. The (automatic/hand) dishwashing composition according to embodiment 2 or 3, wherein the silk polypeptide
   comprises or consists of a protein chain that does not have at least two units of the same sequence motifs (a single unit of amino acids), or
   comprises or consists of at least two identical repetitive units.
5. The (automatic/hand) dishwashing composition according to any of embodiments 2 to 4, wherein the silk polypeptide is free of non-repetitive units.
6. The (automatic/hand) dishwashing composition according to embodiment 4 or 5, wherein the single unit of amino acids or the repetitive units are independently selected from the group consisting of
   module C having an amino acid sequence according to SEQ ID NO: 1 or variants thereof,
   module C^{Cys} having an amino acid sequence according to SEQ ID NO: 2 or variants thereof,
   module C^{Lys} having an amino acid sequence according to SEQ ID NO: 3 or variants thereof.
7. The (automatic/hand) dishwashing composition according to any of embodiments 2 to 6, wherein the silk polypeptide is selected from the group consisting of (C)ₘ, (C)ₘC^{Cys}, (C)ₘC^{Lys}, C^{Cys} (C)ₘ, C^{Lys} (C)ₘ, (C^{Cys})ₘ and (C^{Lys})ₘ, wherein m is an integer of 1 to 96.
8. The (automatic/hand) dishwashing composition according to embodiment 7, wherein the silk polypeptide is selected from the group consisting of C₁, C₂, C₃, C₄, C₅, C₆, C₇, C₈, C₁₆, C₃₂, C₄₈, (C)₁C^{Cys}, (C)₂C^{Cys}, (C)₃C^{Cys}, (C)₄C^{Cys}, (C)₅C^{Cys}, (C)₆C^{Cys}, (C)₇Cys (C)₈C^{Cys}, (C)₁₆C^{Cys}, (C)₃₂C^{Cys}, (C)₄₈C^{Cys}, (C)₁C^{Lys}, (C)₂C^{Lys}, (C)₃C^{Lys}, (C)₄C^{Lys}, (C)₅C^{Lys}, (C)₆C^{Lys}, (C)₇C^{Lys}, (C)₈C^{Lys}, (C)₁₆C^{Lys}, (C)₃₂C^{Lys}, (C)₄₈C^{Lys}, C^{Cys}(C)₁, C^{Cys}(C)₂, C^{Cys}(C)₃, C^{Cys}(C)₄, C^{Cys}(C)₅, C^{Cys}(C)₆, C^{Cys}(C)₇, C^{Cys}(C)₈, C^{Cys}(C)₁₆, C^{Cys}(C)₃₂, C^{Cys}(C)₄₈, C^{Lys}(C)₁, C^{Lys}(C)₂, C^{Lys}(C)₃, C^{Lys}(C)₄, C^{Lys}(C)₅, C^{Lys}(C)₆, C^{Lys}(C)₇, C^{Lys}(C)₈, C^{Lys}(C)₁₆, C^{Lys}(C)₃₂, C^{Lys}(C)₄₈, C^{Cys}₁, C^{Cys}₂, C^{Cys}₃, C^{Cys}₄, C^{Cys}₅, C^{Cys}₆, C^{Cys}₇, C^{Cys}₈, C^{Cys}₁₆, C^{Cys}₃₂, C^{Cys}₄₈, C^{Lys}₁, C^{Lys}₂, C^{Lys}₃, C^{Lys}₄, C^{Lys}₅, C^{Lys}₆, C^{Lys}₇, C^{Lys}₈, C^{Lys} 16, C^{Lys}₃₂ and C^{Lys} 48.
9. The (automatic/hand) dishwashing composition according to any of the preceding embodiments, comprising from 0.0005 to 2.5% by weight, preferably from 0.001 to 2.0% by weight, in particular from 0.005 to 1.5% by weight, based on the total weight of the composition, of at least one structural polypeptide (component a)).
10. The (automatic/hand) dishwashing composition according to any of the preceding embodiments, comprising from 1 to 90% by weight, preferably from 2 to 80% by weight, in particular from 10 to 50% by weight, based on the total weight of the composition, of at least one builder (component b)).
11. The (automatic/hand) dishwashing composition according to any of the preceding embodiments, comprising at least one enzyme (component c)).
12. The (automatic/hand) dishwashing composition according to any of the preceding embodiments, comprising at least one enzyme (component c)) in an amount of at least 0.001% by weight, preferably at least 0.01% by weight, in particular at least 0.05% by weight, enzyme protein based on the total weight of the composition.
13. The (automatic/hand) dishwashing composition according to any of the preceding embodiments, comprising at least one bleach (component d)).
14. The (automatic/hand) dishwashing composition according to any of the preceding embodiments, comprising from 0.5 to 30% by weight, preferably from 1 to 25% by weight, based on the total weight of the composition, of at least one bleach (component d)).
15. The (automatic/hand) dishwashing composition according to any of the preceding embodiments, comprising at least one rheology modifier (component e)).
16. The (automatic/hand) dishwashing composition according to any of the preceding embodiments, comprising from 0.1 to 10% by weight, preferably from 0.3 to 6% by weight, based on the total weight of the composition, of at least one rheology modifier (component e)).
17. The (automatic/hand) dishwashing composition according to any of the preceding embodiments, comprising at least one at least one additive different from components a) to e) (=component f)), preferably selected from surfactants, bases, corrosion inhibitors, defoamers, dyes, fragrances, fillers, tableting aids, disintegrants, solubilizers, organic solvents, electrolytes, optical brighteners, hydrotropes, antiredeposition agents, antimicrobial ingredients, antioxidants and mixtures thereof.
18. The (automatic/hand) dishwashing composition according to any of the preceding embodiments, comprising water (component g)).
19. The (automatic/hand) dishwashing composition according to any of the preceding embodiments, comprising:
   a) at least one structural polypeptide,
   b) at least one builder,
   c) optionally at least one enzyme,
   d) optionally at least one bleach component,
   e) optionally at least one thickener,
   f) optionally at least one further additive different from components a) to e), preferably selected from surfactants, bases, corrosion inhibitors, defoamers, dyes, fragrances, fillers, tableting aids, disintegrants, solubilizers, organic solvents, electrolytes, optical brighteners, hydrotropes, antiredeposition agents, antimicrobial ingredients, antioxidants and mixtures thereof, and
   g) optionally water.
20. The (automatic/hand) dishwashing composition according to any of the preceding embodiments, comprising:
   a) 0.0005 to 2.5% by weight, based on the total weight of the composition, of at least one structural polypeptide,
   b) 1% to 90% by weight, based on the total weight of the composition, of at least one builder,
   c) 0% to 10% by weight (preferably 0.001 to 10% by weight, more preferably 0.005 to 8% by weight, in particular 0.01 to 5% by weight) of at least one enzyme, based on the proportion of enzyme protein in the total weight of the composition,
   d) 0% to 30% by weight (preferably at least 0.5% by weight, more preferably at least 1% by weight), based on the total weight of the composition, of at least one bleach component,
   e) 0% to 10% by weight (preferably at least 0.1% by weight, more preferably at least 0.3% by weight), based on the total weight of the composition, of at least one rheology modifier,
   f) 0% to 90% by weight (preferably at least 0.01% by weight, more preferably at least 0.1% by weight), based on the total weight of the composition, of at least one additive different from components a) to e), preferably selected from surfactants, bases, corrosion inhibitors, defoamers, dyes, fragrances, fillers, tableting aids, disintegrants, solubilizers, organic solvents, electrolytes, optical brighteners, hydrotropes, antiredeposition agents, antimicrobial ingredients, antioxidants and mixtures thereof, and
   g) 0% to 90% by weight (at least 0.1% by weight, more preferably at least 1.0% by weight), based on the total weight of the composition, of water, with the proviso that the weight of components a) to g) adds up to 100% by weight.
21. The (automatic/hand) dishwashing composition according to any of the preceding embodiments, comprising:
   a) 0.001 to 2.0% by weight, based on the total weight of the composition, of at least one structural polypeptide,
   b) 2% to 80% by weight, based on the total weight of the composition, of at least one builder,
   c) 0% to 8% by weight (preferably 0.001 to 10% by weight, more preferably from 0.005 to 8% by weight, in particular from 0.01 to 5% by weight) of at least one enzyme, based on the proportion of enzyme protein in the total weight of the composition,
   d) 0% to 20% by weight (preferably at least 0.5% by weight, more preferably at least 1% by weight), based on the total weight of the composition, of at least one bleach,
   e) 0% to 8% by weight (preferably 0.001 to 10% by weight, more preferably from 0.005 to 8% by weight, in particular from 0.01 to 5% by weight), based on the total weight of the composition, of at least one rheology modifier,
   f) 0% to 80% by weight (preferably at least 0.01% by weight, more preferably at least 0.1% by weight), based on the total weight of the composition, of at least one additive different from components a) to e), preferably selected from surfactants, bases, corrosion inhibitors, defoamers, dyes, fragrances, fillers, tableting aids, disintegrants, solubilizers, organic solvents, electrolytes, optical brighteners, hydrotropes, antiredeposition agents, antimicrobial ingredients, antioxidants and mixtures thereof, and
   g) 0% to 90% by weight (at least 0.1% by weight, more preferably at least 1.0% by weight), based on the total weight of the composition, of water, with the proviso that the weight of components a) to g) adds up to 100% by weight.
22. The (automatic/hand) dishwashing composition according to any of the preceding embodiments, wherein the automatic dishwashing composition is in gel form or the automatic dishwashing composition is a multicompartment formulation containing the structural polypeptide in gel form.
23. The (automatic/hand) dishwashing composition according to any of embodiment 22, wherein the structural polypeptide is in the form of a gel, preferably hydrogel.
24. A method for machine cleaning of dishware, in which the dishware to be cleaned is contacted with a (n) (automatic/hand) dishwashing composition as defined in any of embodiments 1 to 23.
25. The use of a structural polypeptide, especially a silk polypeptide, in a (n) (automatic/hand) dishwashing composition.
26. The use according to embodiment 25, wherein the structural polypeptide is defined as in any of embodiments 2 to 8, 22 or 23.
27. The use according to embodiment 25 or 26 for
   reducing spotting and filming of the dishware, in particular of glassware and cutlery,
   imparting the dishware with a good shine,
   improving the soil removability of the dishware,
   preventing resoiling of the dishware,
   imparting the dishware with a surface protection, in particular preventing corrosive changes of the surfaces of glassware,
   reducing the surface tension of the dishware,
   reducing or eliminating the need for a separate rinse aid product,
   improving the drying of the dishware.
28. The use of a (n) (automatic/hand) dishwashing composition as defined in any of embodiments 1 to 23, in the treatment of soiled dishware (in an automatic dishwasher/by hand) for
   reducing spotting and filming of the dishware, in particular of glassware and cutlery,
   imparting the dishware with a good shine,
   improving the soil removability of the dishware,
   preventing resoiling of the dishware,
   imparting the dishware with a surface protection, in particular preventing corrosive changes of the surfaces of glassware,
   reducing the surface tension of the dishware,
   reducing or eliminating the need for a separate rinse aid product,
   improving the drying of the dishware.

### EXAMPLES

The following examples are illustrative of the automatic dishwashing compositions of the invention. They are not intended to limit the invention described above in any way.

### Example 1

### I) Dishwashing Formulations

### I.1) Gel Formulations

The following gel formulations 1 to 3 were prepared. In each case, formula a) is a comparative examples that dopes not contain a structural protein (silk protein) according to the invention. Formulations b) contain a structural protein (silk protein) according to the invention.

### Formulation 1

a) without structural protein (comparative example)
b) with structural protein gel containing 3 wt. % silk protein (according to the invention)

| Component | wt. % | |
|---|---|---|
| Silk protein gel | 3.0 | (3% active ingredient = 0.09% |
| (formulation b) | | total content of silk protein) |
| Sodium citrate | 30.0 | (50% active ingredient) |
| | | builder |
| Poly acrylic- | 9.0 | builder/chelating agent |
| itaconic copolymer | | |
| Polyacrylic | 1.5 | rheology modifier |
| crosslinked polymer | | |
| C₁₂-C₁₄ EO/PO | 2.2% | (90% active ingredient) |
| alkoxylate | | NI Surfactant |
| Glycerol | 2.0 | solvent |
| Protease | 1.0 | enzyme |
| Amylase | 0.2 | enzyme |
| Benzisothiazolinone | 0.05 | preservative |
| (BIT) | | |
| Sodium hydroxide | q.s. to | |
| deionized water | pH 8.5 | |
| q.s. ad 100% | | |

viscosity [mPas]: 4000 (brookfield, 20 rpm, 24° C.)
pH value: 8.5

### Formulation 2

a) without structural protein (comparative example)
b) with structural protein gel containing 3 wt. % silk protein (according to the invention)

| Component | wt. % | |
|---|---|---|
| Silk protein gel | 3.0 | (3% active ingredient = 0.09% |
| (formulation b) | | total content of silk protein) |
| Sodium polyacrylate | 6.0 | (40% active ingredient) |
| (M_{w} = 4000-6000) | | builder/antiredeposition agent |
| Poly acrylic- | 9.0 | builder/chelating agent |
| maleic copolymer | | |
| EDTA | 4.0 | (40% active ingredient) |
| | | builder/chelating agent |
| Sodium citrate | 0.5 | (100% active ingredient) |
| Xanthan gum | 1.0 | rheology modifier |
| C₁₂-C₁₄ EO/PO | 5.0% | (100% active ingredient) |
| alkoxylate | | NI Surfactant |
| Glycerol | 2.0 | solvent |
| Protease | 4.0 | (40% active ingredient) |
| (Subtilisin) | | enzyme |
| Amylase | 1.0 | (40% active ingredient) |
| | | enzyme |
| Benzisothiazolinone | 0.05 | preservative |
| (BIT) | | |
| Sodium hydroxide | q.s. to | |
| deionized water | pH 8.5 | |
| q.s. ad 100% | | |

pH value: 8.5

### Formulation 3

a) without structural protein (comparative example)
b) with structural protein gel containing 3 wt. % silk protein (according to the invention)

| Component | wt. % | |
|---|---|---|
| Silk protein gel | 3.0 | (3% active ingredient = 0.09% |
| (formulation b) | | total content of silk protein) |
| GLDA | 30.0 | (47% active ingredient) |
| | | builder/chelating agent Sulfonated |
| acrylic copolymer | 8.0 | (40% active ingredient) |
| | | builder/antiredeposition agent |
| Sodium citrate | 0.5 | (100% active ingredient) builder |
| Xanthan gum | 1.0 | rheology modifier |
| C₁₂-C₁₄ EO/PO | 4.0% | (100% active ingredient) |
| alkoxylate | | NI Surfactant |
| Glycerol | 10.0 | solvent |
| Protease | 4.0 | (40% active ingredient) |
| (Subtilisin) | | enzyme |
| Amylase | 1.0 | (40% active ingredient) |
| | | enzyme |
| Benzisothiazolinone | 0.05 | preservative |
| (BIT) | | |
| Sodium hydroxide | q.s. to | |
| deionized water | pH 8.5 | |
| q.s. ad 100% | | |

viscosity [mPas]: 1250 mPas (brookfield, 20 rpm, 24° C.)
pH value: 8.5

### I.2) Multicompartment Formulations

### Formulation 4

(ADW Tabs with 3 compartments. 2 powders and 1 liquid)

| | percentage |
|---|---|
| | total |
| | composition |
| Silk protein gel containing 3 wt. % | 3%^{a)} |
| silk protein (formulation b) | |
| Surfactants | 12.1% |
| Builders | 9.4 |
| Alkali | 31.2 |
| Antiredeposition polymers | 12.3 |
| Solvents | 15.4 |
| Bleach system | 13.6 |
| Enzymes | 2.0 |
| Other additives | 1.0 |

^{a)}i.e. a total content of 0.09% silk protein in the composition

### II) Application Examples

II.1) Cleaning effect of Automatic Dishwasher Gels

The detergency measurements were conducted based on the IKW method: “Recommendations for the Quality Assessment of the Cleaning Performance of Dish-washer Detergents (Part B, Update 2015)” According to IKW method there are 8 types of dirt, which are divided into 4 classes. Corresponding to the composition of dish-washing detergents of bleach, alkali and various enzymes, at least one soil type from each of the four soil classes (bleachable, persistent/alkaline-sensitive, starch-containing/amylase-sensitive and protein containing/protease-sensitive) were used in testing. Eight types of dirt were selected, at least one from each class (see table 1 below). After washing cycle, a visual assessment was carried out, scoring from 0 to 10, depending on the degree of cleaning and type of dirt. The higher the score the better the detergent effect.

### Conditions of IKW Tests

Dishwashing Machine: Bosch
Programme: Eco 50° cycle
Water hardness: 21° GH (general hardness)
Dosing: 25 g gel formulation in the main cycle

The test results are shown in table 1

TABLE 1

| | Gel formulation | | | | | |
|---|---|---|---|---|---|---|
| | 1a | | 2a | | 3a | |
| Type of dirt | (comp.) | 1b | (comp.) | 2b | (com.) | 3b |
| Bleachable | 9.8 | 9.8 | 9.8 | 9.8 | 9.9 | 9.8 |
| Tea | 9.5 | 9.5 | 9.5 | 9.5 | 9.7 | 9.5 |
| Tea with milk | 10.0 | 10.0 | 10.0 | 10.0 | 10.0 | 10.0 |
| Alkaline | 10.0 | 10.0 | 10.0 | 10.0 | 10.0 | 10.0 |
| Milk skin | 10.0 | 10.0 | 10.0 | 10.0 | 10.0 | 10.0 |
| Protein- | 10.0 | 10.0 | 10.0 | 10.0 | 10.0 | 10.0 |
| Containing | | | | | | |
| Crème- | 10.0 | 10.0 | 10.0 | 10.0 | 10.0 | 10.0 |
| Brulee | | | | | | |
| Egg Yolk | 10.0 | 10.0 | 10.0 | 10.0 | 10.0 | 10.0 |
| Minced Meat | 10.0 | 10.0 | 10.0 | 10.0 | 10.0 | 10.0 |
| Starch | 9.4 | 9.4 | 9.5 | 9.5 | 9.5 | 9.5 |
| Containing | | | | | | |
| Pasta | 9.0 | 9.0 | 9.0 | 9.0 | 9.0 | 9.0 |
| Starch Mix | 9.8 | 9.8 | 9.9 | 9.9 | 9.9 | 9.9 |
| Total | 9.8 | 9.8 | 9.8 | 9.8 | 9.8 | 9.8 |

The IKW tests demonstrate a high level of cleaning performance of the tested dishwashing formulations. The presence of the structural protein has no negative impact on the cleaning performance.

### II.2 Shine Performance Test

The level of spotting and filming was assessed and scored on a range of dishwares as follows:
5—extremely strong Spotting/Filming
4—very strong Spotting/Filming
3—strong Spotting/Filming
2—slight Spotting/Filming
1—no Spotting/Filming

### Conditions of Spotting/Filming Tests

Dishwashing Machine: Bosch
Programme: Eco 50° cycle
Water hardness: 21° GH

The results are set out in table 2 below.

TABLE 2

| | Gel formulation | | | | | | | | | | | |
|---|---|---|---|---|---|---|---|---|---|---|---|---|
| | 1a | | | | 2a | | | | 3a | | | |
| | comp. | | 1b | | comp. | | 2b | | comp. | | 3b | |
| dishware | spot | film | spot | film | spot | film | spot | film | spot | film | spot | film |
| Glasses | 4.0 | 3.0 | 3.0 | 2.5 | 3.5 | 2.5 | 2.5 | 2.0 | 4.0 | 3.0 | 3.0 | 2.0 |
| Cutlery | 3.0 | 3.0 | 2.0 | 2.5 | 5.0 | 4.5 | 4.0 | 4.0 | 4.0 | 3.0 | 3.0 | 2.5 |

spot = spotting,
film = filming

The tests demonstrate that the automatic dishwashing formulations according to the invention, comprising a silk protein as structural protein have superior spotting/filming performance.

### Example 2

### Test Method:

Comparative rinse aid test of Automatic Dishwashing Detergents in accordance to Fresenius Standard Method 03 2016.

### Test Conditions:

As washing machine, a Miele GSL 2 was used.
The program was set to 50° C., 8 min, 65° C. Rinsing Cycle.
The Hardness of water was 9±1°dH.
Dosage: 20 ppm in washing liquid
No Rinse Aid was used.
The Number of Cycles was 3 (cumulative).

### Ballast Soil:

50 g Ballast Soil per cycle were used with ingredients: ketchup, milk, starch, fat, egg yolk, benzoic acid and water.

### Machine Loading:

Washing machine was loaded with 6 Plastic Plates Melamin in blue, 3 Plates Glass, black (Arcoroc), 4 Longdrink Glasses (Schott Paris 79), 4 Juice Glasses (Schott Paris 12),

### Samples Used:

IEC 60436-Typ D (Detergent, Batch number CFT-GSM D~020 rev.2020 CFT) is referred to as IEC-D in the following and was used as a detergent.

### Test Procedure:

Glasses and plates were placed in a dishwashing machine and treated with Neodisher and citric acid and two cycles with the test detergent.

The dishwashing machine has been modified in a way that the commercial ion exchanger has been put out of operation. The machine was provided with defined water via an external tank.

The rinse aid dispenser was empty. In case of test usage of rinse aid, it was inserted by hand with a pipette.

In the beginning of cleaning cycle, 50 g of ballast soil were added. After the program was finished, the front door was kept close for additional 10 minutes. Then the door was fully opened and the dishwasher racks were completely pulled out of the machine.

The evaluation was started after 20 minutes. After the crockery was completely dried, the rinse aid effect was evaluated visually in a “black box” under defined light conditions. Any dried drops, streaks, deposit or dull film on the crockery and cutlery was assessed. Three repetitions (cumulative) of each product were tested and the arithmetical mean was calculated.

### Results

1. Visual evaluation Water and Salt Spots

Plates blue Melamin and Plates Glass Arcoroc were treated as described above under test conditions and test procedure.

Briefly described, the plates were placed in a dishwasher together with ballast soil, and either (i) detergent (IEC-D) or (ii) detergent (IEC-D) combined with silk gel were added.

Three repetitions (cumulative) of the washing cycle for each product were performed followed by visual grading for salt and water spots. In addition, the arithmetical mean was calculated.

The visual grading for Spots was carried out by an independent institute (Fresenius Institute) according to an 8-point scale for water and salt spots, where:
8=free of spots and stripes,
7=few very slight stripes and/or few very small spots,
6=few slight stripes and/or some small spots,
5=slight or medium stripes and/or few medium sized spots,
4=few medium stripes and/or medium sized spots,
3=medium stripes and/or few large spots,
2=few large stripes and/or large spots, and
1=large stripes and/or numerous large spots and 0=very large stripes and/or very numerous large spots.

The arithmetical mean for Plates blue Melamin washed with IEC-D was calculated as 3.8, while the arithmetical mean after the addition of IEC-D+spider silk was 5.6.

The arithmetical mean for Plates Glass Arcoroc washed with IEC-D was calculated as 5.6, while the arithmetical mean after the addition of IEC-D+spider silk was 6.0.

In summary, it was observed that the number of spots was reduced when washing Plates blue Melamin and Plates Glass Arcoroc with IEC-D+silk gel compared to washing with only IEC-D (Table 3).

| | Plates | Plates |
|---|---|---|
| | blue Melamin | Glass Arcoroc |
| IEC-D + | 5.6 | 6.0 |
| silk gel | | |
| IEC-D | 3.8 | 5.6 |

Table 3: Shows the results of a Comparative washing detergent test of Automatic Dishwashing Detergents in accordance with Fresenius Standard Method 03_2016. The Detergents IEC 60436-Typ D, here referred to as IEC-D, was tested with and without silk gel. The combinations are compared towards reduction of spot formation on plates, after three repeated cycles of washing (cycle 1=A, cycle 2=B, cycle 3=C), in a washing machine according to Fresenius Standard Method 03_2016 SOP M 2422 Version 2.

### 2. Digital Image Analysis

The tested drinking glasses were evaluated visual and subsequently measured by digital image analyse. For this each glass was fixed on a rack and illuminated with a special source of light. During the digital measuring, the glass turned an angle of 360°. A plane picture is the result. By special software the number of spots, the size and the intensity could be calculated. The bottom and the top of the glass were ignored.

The classification of the results was carried out using the following grading:
5=very big spots,
4=big spots,
3=medium sized spots,
2=small spots, and
1=very small spots.

When glassware was treated with detergent IEC-D—silk gel, medium sized spots were detected on the glass surface after the three cycles of consecutive washing. For the glassware washed with detergent IEC-D+silk gel, only small sized spots were detected on the glass surface after the three cycles of consecutive washing.

The evaluation of spot formation was 3 for the glass samples treated with detergent IEC-D—silk gel, and 2 for the glass samples treated with detergent and rinse aid IEC-D+silk gel.

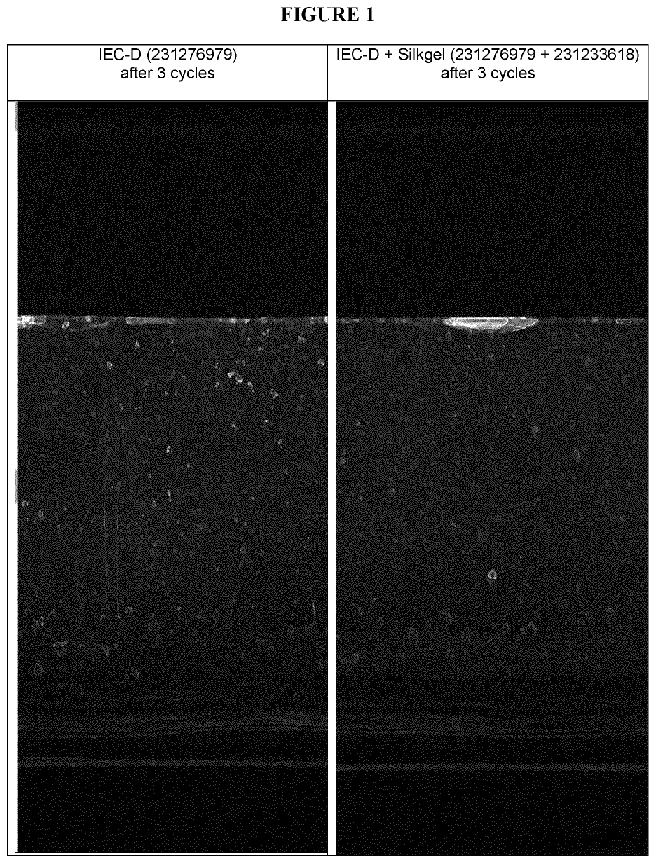

Therefore, the addition of silk gel to detergent IEC-D leads to a reduction of spot formation on glass ware and provides an optical improvement (see FIG. 1).

In the experiments described above, the use of the spider silk polypeptide C₁₆ is preferred.

1. An automatic dishwashing composition, comprising:
a) a structural polypeptide, and
b) at least one builder.

2. The automatic dishwashing composition according to claim 1, wherein the structural polypeptide a) is a silk polypeptide.

3. The automatic dishwashing composition according to claim 2, wherein the silk polypeptide is a recombinant or synthetic silk polypeptide.

4. The automatic dishwashing composition according to claim 2, wherein the silk polypeptide
comprises or consists of a single unit of amino acids, or
comprises or consists of at least two identical repetitive units.

5. The automatic dishwashing composition according claim 4, wherein the silk polypeptide is free of non-repetitive units.

6. The automatic dishwashing composition according to claim 4, wherein the single unit or the repetitive units are independently selected from the group consisting of
module C having an amino acid sequence according to SEQ ID NO: 1 or variants thereof,
module C^{Cys} having an amino acid sequence according to SEQ ID NO: 2 or variants thereof,
module C^{Lys} having an amino acid sequence according to SEQ ID NO: 3 or variants thereof.

7. The automatic dishwashing composition according to claim 6, wherein the silk polypeptide is selected from the group consisting of (C)ₘ, (C)ₘC^{Cys}, (C)ₘC^{Lys}, C^{Cys} (C)ₘ, C^{Lys} (C)ₘ, (C^{Cys})ₘ and (C^{Lys})ₘ, wherein m is an integer of 1 to 96.

8. The automatic dishwashing composition according to claim 7, wherein the silk polypeptide is selected from the group consisting of C₁, C₂, C₃, C₄, C₅, C₆, C₇, C₈, C₁₆, C₃₂, C₄₈, (C)₁C^{Cys}, (C)₂C^{Cys}, (C)₃C^{Cys}, (C)₄C^{Cys}, (C)₅^{Cys}, (C)₆C^{Cys}, (C)₇C^{Cys}, (C)₈C^{Cys}, (C)₁₆C^{Cys}, (C)₃₂C^{Cys}, (C)₄₈C^{Cys}, (C)₁C^{Lys}, (C)₂C^{Lys}, (C)₃C^{Lys}, (C)₄C^{Lys}, (C)₅C^{Lys}, (C)₆C^{Lys}, (C)₇C^{Lys}, (C)₈C^{Lys}, (C)₁₆C^{Lys}, (C)₃₂C^{Lys}, (C)₄₈C^{Lys}, C^{Cys} (C)₁, C^{Cys} (C)₂, C^{Cys} (C)₃, C^{Cys} (C)₄, C^{Cys} (C)₅, C^{Cys}(C)₆, C^{Cys}(C)₇, C^{Cys}(C)₈, C^{Cys}(C)₁₆, C^{Cys}(C)₃₂, C^{Cys}(C)₄₈, C^{Lys}(C)₁, C^{Lys}(C)₂, C^{Lys}(C)₃, C^{Lys}(C)₄, C^{Lys}(C)₅, C^{Lys}(C)₆, C^{Lys}(C)₇, C^{Lys}(C)₈, C^{Lys}(C)₁₆, C^{Lys}(C)₃₂, C^{Lys}(C)₄₈, C^{Cys}₁, C^{Cys}₂, C^{Cys}₃, C^{Cys}₄, C^{Cys}₅, C^{Cys}₆, C^{Cys}₇, C^{Cys}₈, C^{Cys}₁₆, C^{Cys}₃₂, C^{Cys}₄₈, C^{Lys} 1, C^{Lys}₂, C^{Lys}₃, C^{Lys}₄, C^{Lys}₅, C^{Lys}₆, C^{Lys}₇, C^{Lys}₈, C^{Lys}₁₆, C^{Lys}₃₂ and C^{Lys}₄₈.

9. The automatic dishwashing composition according to claim 1, comprising from 0.0005 to 2.5% by weight based on the total weight of the composition, of at least one structural polypeptide (component a)).

10. The automatic dishwashing composition according to claim 1, comprising:
a) at least one structural polypeptide,
b) at least one builder,
c) optionally at least one enzyme,
d) optionally at least one bleach component,
e) optionally at least one thickener,
f) optionally at least one further additive different from components a) to e) selected from surfactants, bases, corrosion inhibitors, defoamers, dyes, fragrances, fillers, tableting aids, disintegrants, solubilizers, organic solvents, electrolytes, optical brighteners, hydrotropes, antiredeposition agents, antimicrobial ingredients, antioxidants and mixtures thereof, and
g) optionally water.

11. The automatic dishwashing composition according to claim 1, wherein the automatic dishwashing composition is in gel form or the automatic dishwashing composition is a multicompartment formulation containing the structural polypeptide in gel form.

12. A method for machine cleaning of dishware, in which the dishware to be cleaned is contacted with an automatic dishwashing composition as defined in claim 1.

13. (canceled)

14. A method for
reducing spotting and filming of dishware,
imparting dishware with a good shine,
improving the soil removability of dishware,
preventing resoiling of dishware,
imparting dishware with a surface protection,
reducing the surface tension of dishware,
improving the drying of dishware,
in which the dishware to be cleaned is contacted with an automatic dishwashing composition as defined in claim 1.

15. (canceled)

16. The automatic dishwashing composition according to claim 2, wherein the silk polypeptide is a spider silk polypeptide.

17. The automatic dishwashing composition according to claim 1, wherein the structural polypeptide is in the form of a gel.

18. The automatic dishwashing composition according to claim 17, wherein the gel is a hydrogel.

19. The automatic dishwashing composition according to claim 1, wherein the composition comprises from 1 to 90% by weight, based on the total weight of the composition, at least one builder (component b)).

20. The automatic dishwashing composition according to claim 1, wherein the composition comprises at least one enzyme (component c)) in an amount of at least 0.001% by weight based on the total weight of the composition.


SEQUENCE LISTING (10 sequences)

SEQ ID NO: 1 - protein, 35 aa, synthetic construct
GSSAAAAAAAASGPGGYGPENQGPSGPGGYGPGGP

SEQ ID NO: 2 - protein, 35 aa, synthetic construct
GSSAAAAAAAASGPGGYGPENQGPCGPGGYGPGGP

SEQ ID NO: 3 - protein, 35 aa, synthetic construct
GSSAAAAAAAASGPGGYGPKNQGPSGPGGYGPGGP

SEQ ID NO: 4 - protein, 11 aa, synthetic construct
MASMTGGQQMG

SEQ ID NO: 5 - protein, 4 aa, synthetic construct
RGSM

SEQ ID NO: 6 - protein, 576 aa, synthetic construct
MASMTGGQQMGRGSMGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPG

SEQ ID NO: 7 - protein, 576 aa, synthetic construct
MASMTGGQQMGRGSMGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPG

SEQ ID NO: 8 - protein, 610 aa, synthetic construct
MASMTGGQQMGRGSMGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPCGPGGYGPGGP

SEQ ID NO: 9 - protein, 1136 aa, synthetic construct
MASMTGGQQMGRGSMGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPG

SEQ ID NO: 10 - protein, 1696 aa, synthetic construct
MASMTGGQQMGRGSMGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPG